(19) United States
(12) Patent Application Publication
(10) Pub. No.: US 2015/0235405 A1
(43) Pub. Date: Aug. 20, 2015

(54) DISPLAY OF A DATA SOURCE INDICATOR AND A DATA SINK INDICATOR

(71) Applicant: Nokia Corporation, Espoo (FI)

(72) Inventors: Jussi Artturi LEPPANEN, Tampere (FI); Arto Juhani LEHTINIEMI, Lempaala (FI); Antti Johannes ERONEN, Tampere (FI)

(21) Appl. No.: 14/182,173

(22) Filed: Feb. 17, 2014

(51) Int. Cl. G06T 13/80; G06F 3/0481

(52) U.S. Cl. CPC G06T 13/80; G06F 3/04817; G06T 2213/12

(57) ABSTRACT

A method comprising causing display of a plurality of program interface elements, identifying, from the plurality of program interface elements, of at least one source program interface element that represents a source program, the source program being a program that is configured to send data to one or more programs, causing display of a data source indicator at a position that corresponds with a position of the source program interface element, identifying, from the plurality of program interface elements, of at least one sink program interface element that represents a sink program, the sink program being a program that is configured to receive data from one or more programs, and causing the sink program interface element to comprise a data sink indicator is disclosed.

### TECHNICAL FIELD

The present application relates generally to display of data source indicator and a data sink indicator.

### BACKGROUND

As users have become more reliant on their electronic apparatuses, many users have developed various needs for such apparatuses to perform particularized functions. For example, many users may rely on their apparatuses for updating social media services, consuming media, sending messages, receiving messages, performing calls, etc. As users have become more adept with performing such activities with their apparatuses, many users may desire to perform such activities in conjunction with each other, such as listening to music while sending a message. In some circumstances, such activities may be related. For example, a user may desire to send a message that informs a recipient that the user is listening to a particular song. In such circumstances, it may be desirable to allow a user to perform such activities in a simple and intuitive manner.

### SUMMARY

Various aspects of examples of the invention are set out in the claims.

One or more embodiments may provide an apparatus, a computer readable medium, a non-transitory computer readable medium, a computer program product, and a method for causing display of a plurality of program interface elements, identifying, from the plurality of program interface elements, of at least one source program interface element that represents a source program, the source program being a program that is configured to send data to one or more programs, causing display of a data source indicator at a position that corresponds with a position of the source program interface element, identifying, from the plurality of program interface elements, of at least one sink program interface element that represents a sink program, the sink program being a program that is configured to receive data from one or more programs, and causing the sink program interface element to comprise a data sink indicator.

One or more embodiments may provide an apparatus, a computer readable medium, a computer program product, and a non-transitory computer readable medium having means for causing display of a plurality of program interface elements, means for identifying, from the plurality of program interface elements, of at least one source program interface element that represents a source program, the source program being a program that is configured to send data to one or more programs, means for causing display of a data source indicator at a position that corresponds with a position of the source program interface element, means for identifying, from the plurality of program interface elements, of at least one sink program interface element that represents a sink program, the sink program being a program that is configured to receive data from one or more programs, and means for causing the sink program interface element to comprise a data sink indicator.

In at least one example embodiment, a program interface element is a visual representation of a program.

In at least one example embodiment, the visual representation of the program is at least one of a tile or an icon.

One or more example embodiments further perform initiation of a program data connection interaction mode, wherein the identification of the source program interface element is based, at least in part, on the initiation of the program data connection interaction mode.

In at least one example embodiment, the program data connection interaction mode is characterized by inputs causing modification of data connections between one or more programs.

In at least one example embodiment, the program data connection interaction mode is characterized by preclusion of program invocation by way of selection of a program icon.

One or more example embodiments further perform receipt of information indicative of a program interface element invocation input, and avoidance of invocation of a program indicated by the program interface element invocation input based, at least in part, on the program data connection interaction mode.

One or more example embodiments further perform receipt of information indicative of a program data connection interaction mode invocation input, wherein the initiation of the program data connection interaction mode is based, at least in part, on the program data connection interaction mode invocation input.

One or more example embodiments further perform termination of the program data connection interaction mode.

One or more example embodiments further perform receipt of information indicative of a program data connection interaction mode termination input, wherein the termination of the program data connection interaction mode is based, at least in part, on the program data connection interaction mode termination input.

In at least one example embodiment, the causation of the sink program interface element to comprise the data sink indicator comprises replacement of the sink program interface element with a different sink program interface element that comprises the data sink indicator.

In at least one example embodiment, the causation of the sink program interface element to comprise the data sink indicator comprises combination of the data sink indicator with the sink program interface element.

In at least one example embodiment, the data sink indicator is a visual representation that signifies that a program represented by a program interface element is a sink program.

In at least one example embodiment, the data sink indicator is a program data connection invocation interface element comprised by the sink program interface element.

In at least one example embodiment, the data sink indicator is a visual representation of an indentation at an edge of the sink program interface element.

In at least one example embodiment, a shape of the indentation corresponds with a shape of an edge of the data source indicator.

In at least one example embodiment, the data source indicator is a visual representation that signifies that a program represented by a program interface element is a source program.

In at least one example embodiment, the position of the data source indicator is such that an entirety of the data source indicator is within a boundary of the source program interface element.

In at least one example embodiment, the position of the data source indicator corresponds with a boundary of the source program interface element such that a portion of the data source indicator is within the boundary of the source program interface element and another portion of the data source indicator is beyond the boundary of the source program interface element.

In at least one example embodiment, a shape of the other portion of the data source indicator corresponds with a shape of an edge of the data sink indicator.

In at least one example embodiment, the data source indicator comprises a data source type indicator that is indicative of a data type of the data source indicator.

In at least one example embodiment, the data type of the data source indicator is a data type of data that is sent from the source program to the sink program.

In at least one example embodiment, the data type indicator signifies at least one of contact data, music data, message data, video data, or document content data.

One or more example embodiments further perform determination that the source program is configured to send data of a different data type to one or more programs, and causation of display of another data source indicator at a position that corresponds with the position of the source program interface element, the other data source indicator comprising a different data type indicator that signifies the different data type.

In at least one example embodiment, identification of the source program interface element is based, at least in part, on an interface descriptor of the source program.

In at least one example embodiment, the interface descriptor is information indicative of data that the source program is configured to send to another program.

In at least one example embodiment, identification of the sink program interface element is based, at least in part, on an interface descriptor of the sink program.

In at least one example embodiment, the interface descriptor is information indicative of data that the sink program is configured to receive from another program.

One or more example embodiments further perform receipt of information indicative of a selection input that occurs at a position that corresponds with a position of the data source indicator, receipt of information indicative of a movement input from the position of the data source indicator to a position of the data sink indicator, receipt of information indicative of a deselection input that occurs at a position that corresponds with the position of the data sink indicator, and causation of establishment of a data connection between the source program and the sink program based, at least in part, on the selection input, the movement input, and the deselection input.

In at least one example embodiment, the establishment of the data connection comprises association of an interface of the sink program with the source program.

One or more example embodiments further perform causation of display of another data source indicator at a position that corresponds with a position of the movement input, such that as the position of the movement input changes, the position of the other data source indicator changes to remain in correspondence with the position of the movement input.

In at least one example embodiment, the appearance of the other data source indicator is the same as the appearance of the data source indicator.

One or more example embodiments further perform termination of display of the data source indicator at the position that corresponds with the position of the source program interface element, and causation of display of the data source indicator at a position that corresponds with the position of the data sink indicator.

One or more example embodiments further perform causation of display of a connection indicator between the source program interface element and the sink program interface element.

One or more example embodiments further perform causation of display of a connection indicator between the source program interface element and the data source indicator.

One or more example embodiments further perform initiation of a program invocation interaction mode, determination that a data connection exists between the source program and the sink program, and causation of the source program to send data to the sink program based, at least in part, on the data connection between the source program and the sink program.

One or more example embodiments further perform causation of display of a connection indicator between the source program interface element and the sink program interface element based, at least in part, on the data connection.

In at least one example embodiment, the connection indicator is a line that has an endpoint at a position that corresponds with the position of the source program interface element and another endpoint at a position that corresponds with the position of the sink program interface element.

One or more example embodiments further perform causation of display of an animation in relation to the connection indicator that is indicative of the source program sending the data to the sink program.

In at least one example embodiment, the animation comprises movement of one or more colored bands along the connection indicator in a direction from the source program interface element to the sink program interface element.

In at least one example embodiment, the animation comprises movement of a data indicator along the connection indicator in a direction from the source program interface element to the sink program interface element.

In at least one example embodiment, the data indicator is a shape that extends beyond the width of the connection indicator.

In at least one example embodiment, the data indicator comprises a data type indicator.

One or more example embodiments further perform termination of display of the data source indicator and the data sink indicator based, at least in part, on the initiation of a program invocation interaction mode.

One or more example embodiments further perform causation of the sink program interface element to comprise a data source indicator based, at least in part, on the data connection between the source program and the sink program.

In at least one example embodiment, the sink program interface element comprises the data source indicator such that the data source indicator is represented by way of an animation of the sink program interface element being flipped from a represented surface of the sink program interface element to present a different represented surface of the sink program interface element that comprises the data source indicator.

One or more example embodiments further perform causation of the sink program interface element to comprise a data element indicator that represents the data that was sent from the source program to the sink program.

In at least one example embodiment, the sink program interface element comprises the data element indicator such that the data source indicator is represented by way of an animation of the sink program interface element being flipped from a represented surface of the sink program interface element to present a different represented surface of the sink program interface element that comprises the data element indicator.

### BRIEF DESCRIPTION OF THE DRAWINGS

For a more complete understanding of embodiments of the invention, reference is now made to the following descriptions taken in connection with the accompanying drawings in which:

FIG. 1 is a block diagram showing an apparatus according to at least one example embodiment;

FIGS. 2A-2B are diagrams illustrating a program sending data to another program according to at least one example embodiment;

FIGS. 3A-3D are diagrams illustrating interaction modes according to at least one example embodiment;

FIGS. 4A-4D are diagrams illustrating a program data connection interaction mode according to at least one example embodiment;

FIGS. 5A-5D are diagrams illustrating a program data connection interaction mode according to at least one example embodiment;

FIGS. 6A-6C are diagrams illustrating a connection indicator according to at least one example embodiment;

FIGS. 7A-7G are diagrams illustrating a program interface element according to at least one example embodiment;

FIG. 8 is a flow diagram illustrating activities associated with program data connection indication according to at least one example embodiment;

FIG. 9 is a flow diagram illustrating activities associated with program data connection indication according to at least one example embodiment;

FIG. 10 is a flow diagram illustrating activities associated with program data connection indication according to at least one example embodiment;

FIG. 11 is a flow diagram illustrating activities associated with program data connection indication according to at least one example embodiment; and

FIGS. 12A and 12B are a flow diagram illustrating activities associated with program data connection indication according to at least one example embodiment.

### DETAILED DESCRIPTION OF THE DRAWINGS

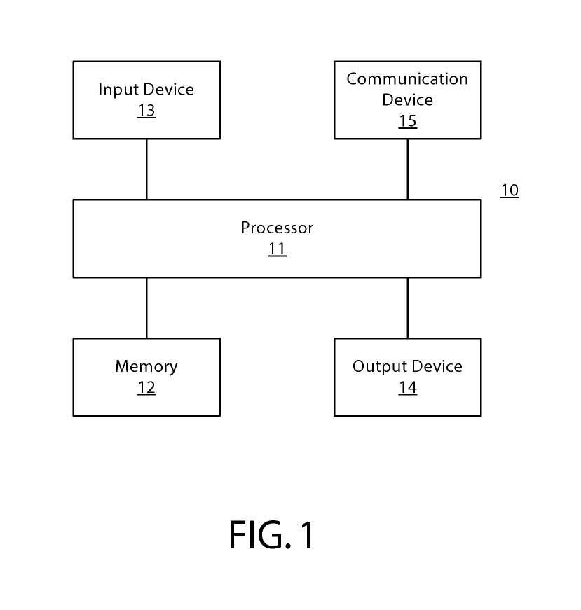

An embodiment of the invention and its potential advantages are understood by referring to FIGS. 1 through 12B of the drawings.

Some embodiments will now be described more fully hereinafter with reference to the accompanying drawings, in which some, but not all, embodiments are shown. Various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network apparatus, other network apparatus, and/or other computing apparatus.

As defined herein, a “non-transitory computer-readable medium,” which refers to a physical medium (e.g., volatile or non-volatile memory device), can be differentiated from a “transitory computer-readable medium,” which refers to an electromagnetic signal.

FIG. 1 is a block diagram showing an apparatus, such as an electronic apparatus 10, according to at least one example embodiment. It should be understood, however, that an electronic apparatus as illustrated and hereinafter described is merely illustrative of an electronic apparatus that could benefit from embodiments of the invention and, therefore, should not be taken to limit the scope of the invention. While electronic apparatus 10 is illustrated and will be hereinafter described for purposes of example, other types of electronic apparatuses may readily employ embodiments of the invention. Electronic apparatus 10 may be a personal digital assistant (PDAs), a pager, a mobile computer, a desktop computer, a television, a gaming apparatus, a laptop computer, a tablet computer, a media player, a camera, a video recorder, a wearable apparatus, a head mounted apparatus, a see through display apparatus, a mobile phone, a global positioning system (GPS) apparatus, an automobile, a kiosk, an electronic table, and/or any other types of electronic systems. Moreover, the apparatus of at least one example embodiment need not be the entire electronic apparatus, but may be a component or group of components of the electronic apparatus in other example embodiments. For example, the apparatus may be an integrated circuit, a set of integrated circuits, and/or the like.

Furthermore, apparatuses may readily employ embodiments of the invention regardless of their intent to provide mobility. In this regard, even though embodiments of the invention may be described in conjunction with mobile applications, it should be understood that embodiments of the invention may be utilized in conjunction with a variety of other applications, both in the mobile communications industries and outside of the mobile communications industries. For example, the apparatus may be, at least part of, a non-carryable apparatus, such as a large screen television, an electronic table, a kiosk, an automobile, and/or the like.

In at least one example embodiment, electronic apparatus 10 comprises processor 11 and memory 12. Processor 11 may be any type of processor, controller, embedded controller, processor core, and/or the like. In at least one example embodiment, processor 11 utilizes computer program code to cause an apparatus to perform one or more actions. Memory 12 may comprise volatile memory, such as volatile Random Access Memory (RAM) including a cache area for the temporary storage of data and/or other memory, for example, non-volatile memory, which may be embedded and/or may be removable. The non-volatile memory may comprise an EEPROM, flash memory and/or the like. Memory 12 may store any of a number of pieces of information, and data. The information and data may be used by the electronic apparatus 10 to implement one or more functions of the electronic apparatus 10, such as the functions described herein. In at least one example embodiment, memory 12 includes computer program code such that the memory and the computer program code are configured to, working with the processor, cause the apparatus to perform one or more actions described herein.

The electronic apparatus 10 may further comprise a communication device 15. In at least one example embodiment, communication device 15 comprises an antenna, (or multiple antennae), a wired connector, and/or the like in operable communication with a transmitter and/or a receiver. In at least one example embodiment, processor 11 provides signals to a transmitter and/or receives signals from a receiver. The signals may comprise signaling information in accordance with a communications interface standard, user speech, received data, user generated data, and/or the like. Communication device 15 may operate with one or more air interface standards, communication protocols, modulation types, and access types. By way of illustration, the electronic communication device 15 may operate in accordance with second-generation (2G) wireless communication protocols IS-136 (time division multiple access (TDMA)), Global System for Mobile communications (GSM), and IS-95 (code division multiple access (CDMA)), with third-generation (3G) wireless communication protocols, such as Universal Mobile Telecommunications System (UMTS), CDMA2000, wideband CDMA (WCDMA) and time division-synchronous CDMA (TD-SCDMA), and/or with fourth-generation (4G) wireless communication protocols, wireless networking protocols, such as 802.11, short-range wireless protocols, such as Bluetooth, and/or the like. Communication device 15 may operate in accordance with wireline protocols, such as Ethernet, digital subscriber line (DSL), asynchronous transfer mode (ATM), and/or the like.

Processor 11 may comprise means, such as circuitry, for implementing audio, video, communication, navigation, logic functions, and/or the like, as well as for implementing embodiments of the invention including, for example, one or more of the functions described herein. For example, processor 11 may comprise means, such as a digital signal processor device, a microprocessor device, various analog to digital converters, digital to analog converters, processing circuitry and other support circuits, for performing various functions including, for example, one or more of the functions described herein. The apparatus may perform control and signal processing functions of the electronic apparatus 10 among these devices according to their respective capabilities. The processor 11 thus may comprise the functionality to encode and interleave message and data prior to modulation and transmission. The processor 1 may additionally comprise an internal voice coder, and may comprise an internal data modem. Further, the processor 11 may comprise functionality to operate one or more software programs, which may be stored in memory and which may, among other things, cause the processor 11 to implement at least one embodiment including, for example, one or more of the functions described herein. For example, the processor 11 may operate a connectivity program, such as a conventional internet browser. The connectivity program may allow the electronic apparatus 10 to transmit and receive internet content, such as location-based content and/or other web page content, according to a Transmission Control Protocol (TCP), Internet Protocol (IP), User Datagram Protocol (UDP), Internet Message Access Protocol (IMAP), Post Office Protocol (POP), Simple Mail Transfer Protocol (SMTP), Wireless Application Protocol (WAP), Hypertext Transfer Protocol (HTTP), and/or the like, for example.

The electronic apparatus 10 may comprise a user interface for providing output and/or receiving input. The electronic apparatus 10 may comprise an output device 14. Output device 14 may comprise an audio output device, such as a ringer, an earphone, a speaker, and/or the like. Output device 14 may comprise a tactile output device, such as a vibration transducer, an electronically deformable surface, an electronically deformable structure, and/or the like. Output device 14 may comprise a visual output device, such as a display, a light, and/or the like. In at least one example embodiment, the apparatus causes display of information, the causation of display may comprise displaying the information on a display comprised by the apparatus, sending the information to a separate apparatus that comprises a display, and/or the like. The electronic apparatus may comprise an input device 13. Input device 13 may comprise a light sensor, a proximity sensor, a microphone, a touch sensor, a force sensor, a button, a keypad, a motion sensor, a magnetic field sensor, a camera, and/or the like. A touch sensor and a display may be characterized as a touch display. In an embodiment comprising a touch display, the touch display may be configured to receive input from a single point of contact, multiple points of contact, and/or the like. In such an embodiment, the touch display and/or the processor may determine input based, at least in part, on position, motion, speed, contact area, and/or the like. In at least one example embodiment, the apparatus receives an indication of an input. The apparatus may receive the indication from a sensor, a driver, a separate apparatus, and/or the like. The information indicative of the input may comprise information that conveys information indicative of the input, indicative of an aspect of the input indicative of occurrence of the input, and/or the like.

The electronic apparatus 10 may include any of a variety of touch displays including those that are configured to enable touch recognition by any of resistive, capacitive, infrared, strain gauge, surface wave, optical imaging, dispersive signal technology, acoustic pulse recognition or other techniques, and to then provide signals indicative of the location and other parameters associated with the touch. Additionally, the touch display may be configured to receive an indication of an input in the form of a touch event which may be defined as an actual physical contact between a selection object (e.g., a finger, stylus, pen, pencil, or other pointing device) and the touch display. Alternatively, a touch event may be defined as bringing the selection object in proximity to the touch display, hovering over a displayed object or approaching an object within a predefined distance, even though physical contact is not made with the touch display. As such, a touch input may comprise any input that is detected by a touch display including touch events that involve actual physical contact and touch events that do not involve physical contact but that are otherwise detected by the touch display, such as a result of the proximity of the selection object to the touch display. A touch display may be capable of receiving information associated with force applied to the touch screen in relation to the touch input. For example, the touch screen may differentiate between a heavy press touch input and a light press touch input. In at least one example embodiment, a display may display two-dimensional information, three-dimensional information and/or the like.

In embodiments including a keypad, the keypad may comprise numeric (for example, 0-9) keys, symbol keys (for example, #, *), alphabetic keys, and/or the like for operating the electronic apparatus 10. For example, the keypad may comprise a conventional QWERTY keypad arrangement. The keypad may also comprise various soft keys with associated functions. In addition, or alternatively, the electronic apparatus 10 may comprise an interface device such as a joystick or other user input interface.

Input device 13 may comprise a media capturing element. The media capturing element may be any means for capturing an image, video, and/or audio for storage, display or transmission. For example, in at least one example embodiment in which the media capturing element is a camera module, the camera module may comprise a digital camera which may form a digital image file from a captured image. As such, the camera module may comprise hardware, such as a lens or other optical component(s), and/or software necessary for creating a digital image file from a captured image. Alternatively, the camera module may comprise only the hardware for viewing an image, while a memory device of the electronic apparatus 10 stores instructions for execution by the processor 11 in the form of software for creating a digital image file from a captured image. In at least one example embodiment, the camera module may further comprise a processing element such as a co-processor that assists the processor 11 in processing image data and an encoder and/or decoder for compressing and/or decompressing image data. The encoder and/or decoder may encode and/or decode according to a standard format, for example, a Joint Photographic Experts Group (JPEG) standard format.

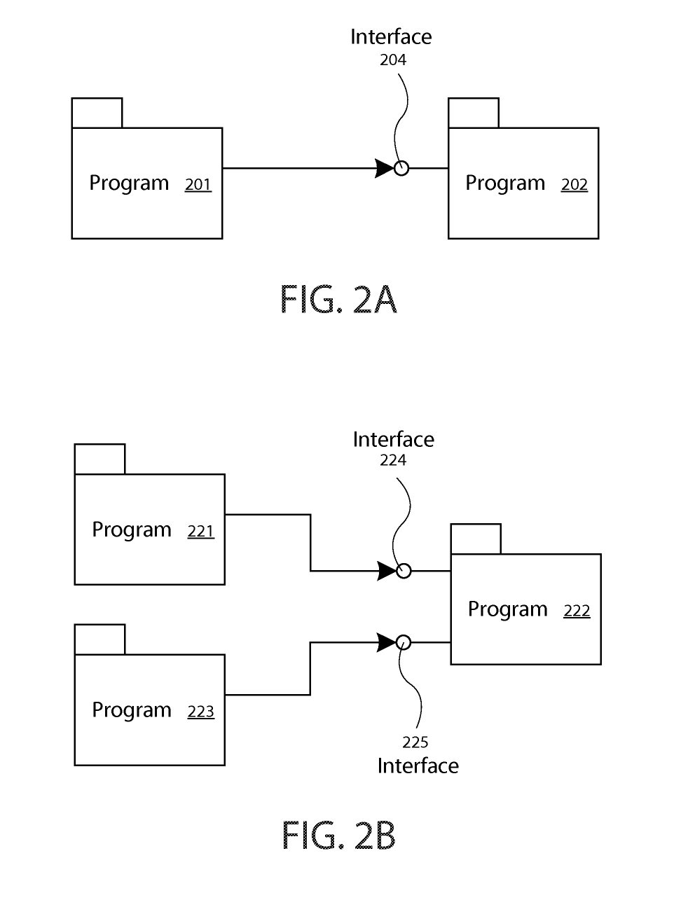

FIGS. 2A-2B are diagrams illustrating a program sending data to another program according to at least one example embodiment. The examples of FIGS. 2A-2B are merely examples and do not limit the scope of the claims. For example, number of programs may vary, number of interfaces may vary, data connections between programs may vary, and/or the like.

As many users have become more adept at utilizing their apparatuses, many users have developed a wide variety of manners in which they utilize their apparatuses. As such, there has been a proliferation of programs that a user may desire to have operating on his apparatus. For example, a particular user may desire to operate social media and music programs on his apparatus, and a different user may desire to operate email and mathematical programs on his apparatus. In this manner, users have been able to tailor their particular apparatus requirements by way of selecting various programs to operate on their apparatuses.

In some circumstances, such programs may be configurable to share data between each other. For example, a program may be configured to send data to another program. In this manner, the other program may utilize data that is sent to it from the program. Such configuration allows for robust cross-program behavior that a user may desire. For example, the user may desire his actions in a particular program to affect operation of a different program. For example, the user may desire a music player program to affect the manner in which a social media program operates.

FIG. 2A is a diagram illustrating a program sending data to another program according to at least one example embodiment. In the example of FIG. 2A, program 202 implements interface 204 such that other programs may send data to program 202 by way of interface 204. In the example of FIG. 2A, program 201 is configured to send data to program 202 by way of interface 204. In this manner, program 201 has a data connection to program 202 by way of interface 204. In at least one example embodiment, a data connection between a program and another program refers to the program being associated with an interface of the other program such that the program is configured to send data to the other program. In at least one example embodiment, a data connection between a program and another program comprises an association between the program and the other program. For example, the data connection between program 201 and 202 comprises the association from program 201 to interface 204, which is implemented by program 202.

In at least one example embodiment, a program that is configured to send data to one or more other programs is referred to as a source program. In the example of FIG. 2A, program 201 is a source program. In at least one example embodiment, a program that is configured to receive data from another program is referred to as a sink program. In the example of FIG. 2A, program 202 is a sink program. In at least one example embodiment, a data connection exists between the source program and the sink program that allows the source program to send data to the sink program. An apparatus may determine that the data connection exists, may cause establishment of the data connection, and/or the like. For example, the apparatus may evaluate linkage information associated with the programs, may modify linkage information associated with the programs, and/or the like. In at least one example embodiment, an apparatus establishes a data connection between programs. In at least one example embodiment, the establishment of the data connection comprises association of an interface of the sink program with the source program. In this manner, the apparatus may utilize the data connection for sending data from the source program to the sink program. In at least one example embodiment, the apparatus causes the source program to send data to the sink program based, at least in part, on the data connection between the source program and the sink program. For example, the apparatus may cause such sending and/or receiving by the establishment of the data connection between the source program and the sink program.

In some circumstances, an interface implemented by a program may be associated with a particular data type. In this manner, the interface may govern sending of data in conformance with the particular data type, may govern receipt of data in conformance with the particular data type, and/or the like. In this manner, data that is sent from a program to another program may be data of a particular data type. Similarly, data that is received by a program from another program may be data of a particular type. Similarly, a program may implement a plurality of interfaces such that different interfaces are utilized for communication of different data types. In at least one example embodiment, a data type refers to text data, contact data, audio data, video data, document data, binary data, file data, and/or the like. For example, a program may implement an interface that allows the program to receive music from another program, and may implement another interface that allows the program to receive text information from another program. Likewise, a program may be configured to send different data types to other programs. For example, a program may send music data to another program, and may send text information to another program.

In at least one example embodiment, a program may be configured to send information to a designated other program. In such an example, the apparatus may utilize an interface descriptor to determine information that may be sent by a program, information that may be received by a program, and/or the like. For example, an interface descriptor may indicate that a particular program is configured to send text information and receive music information. In this manner, the apparatus may utilize the interface descriptor to establish a data connection between a program and another program such that the data type being sent by the program corresponds with the data type received by the other program. In at least one example embodiment, the interface descriptor is information indicative of data that the sink program is configured to receive from another program.

FIG. 2B is a diagram illustrating a program sending data to another program according to at least one example embodiment. In the example of FIG. 2B, program 222 implements interfaces 224 and 225. In some circumstances, interface 224 may be configured to receive a different data type than interface 225. In the example of FIG. 2B, a data connection exists between program 221 and program 222 by way of program 221 having an association with interface 224, which is implemented by program 222. Similarly, in the example of FIG. 2B, a data connection exists between program 223 and program 222 by way of program 223 having an association with interface 225, which is implemented by program 222.

In some circumstances, it may be desirable for a user to be able to configure data connections between programs. For example, a user may desire that a particular program provide data to another program. In such an example, a user may desire that a music player program provide text information to a social media program, so that the social media program publishes information based, at least in part, on the text information received from the music player program. For example, the user may desire that the social media program publishes information indicating a song to which the user is listening, an artist to which the user is listening, and/or the like.

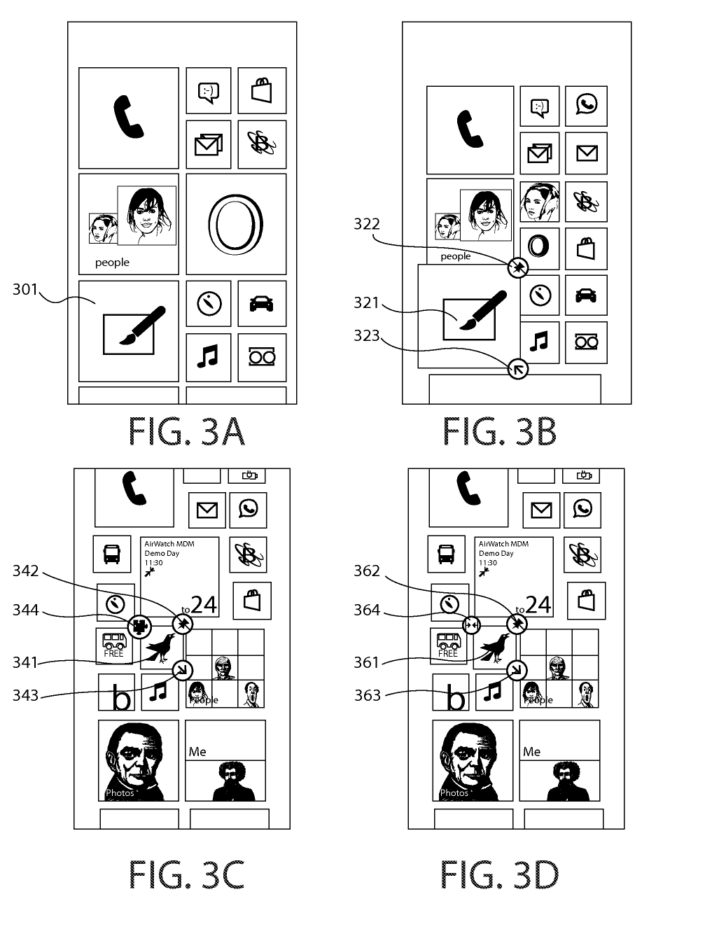

FIGS. 3A-3D are diagrams illustrating interaction modes according to at least one example embodiment. The examples of FIGS. 3A-3D are merely examples and do not limit the scope of the claims. For example, program interface elements may vary, arrangement of program interface elements may vary, orientation of the program interface elements may vary, and/or the like.

In many circumstances, a user is accustomed to interacting with a program by way of a program interface element. In at least one example embodiment, a program interface element is a visual representation of a program. For example, the visual representation of the program may be a tile, an icon, a widget, and/or the like, such that the user may identify the program by way of by the visual representation. For example, a user may be accustomed to launching a program by way of performing a selection input that corresponds with the program interface element that represents the program. In this manner, the user may be accustomed to identifying operation that a program performs with the program interface element the represents the program.

In at least one example embodiment, an apparatus may provide a plurality of interaction modes that govern the manner in which a user interacts with program interface elements. For example, an apparatus may provide for a program invocation interaction mode. In at least one example embodiment, a program invocation interaction mode is a mode of operation wherein the apparatus invokes operation of the program represented by a program interface element in response to a particular input. For example, the apparatus may cause display of a plurality of program interface elements, and allow for invocation of a program represented by a particular program interface element by way of receipt of one or more inputs. In such an example, the apparatus may receive information indicative of a program interface element invocation input, and invoke the program indicated by the program interface element invocation input. In such an example, the apparatus may cause invocation of the program based, at least in part, on the program data invocation interaction mode. In at least one example embodiment, the apparatus determines that a particular input is associated with a particular program interface element by way of correspondence between a position of the input and a position of the program interface element. For example, the input may be a touch input at a particular position on a touch display. In such an example, the apparatus may determine that the input is associated with the particular program interface element by way of the position of the touch input corresponding with a position of the particular program interface element.

FIG. 3A is a diagram illustrating a program invocation interaction mode according to at least one example embodiment. In the example of FIG. 3A, the apparatus has caused display of a plurality of program interface elements, which includes program interface element 301. In this manner, the apparatus may invoke operation of a program represented by program interface element in response to a program interface element invocation input.

In some circumstances, an apparatus may provide for a program interface element arrangement interaction mode. In such an example, the apparatus may cause movement and/or reconfiguration of program interface elements based, at least in part, on received input. For example, the apparatus may allow a user to move a program interface element from a position on the display to a different position on the display, to change the program interface element from a size to a different size, and/or the like. In this manner, in the program interface element arrangement interaction mode, the apparatus may avoid invocation of program represented by program interface elements so that inputs may be utilized for arrangement of the program interface elements.

FIG. 3B is a diagram illustrating a program interface element arrangement interaction mode according to at least one example embodiment. It can be seen that program interface element 321 is larger than other program interface elements. In this manner, the size of program interface element 321 indicates that inputs performed in association with program interface element 321 will cause movement and/or reconfiguration of program interface element 321. It can be seen that program interface element 321 comprises removal indicator 322 and resize indicator 323. In at least one example embodiment, the apparatus will cause removal of the program interface element from the display based, at least in part, on an input that corresponds with removal indicator 322. Similarly, the apparatus may cause a change of size of the program interface element based, at least in part, on an input that corresponds with resize indicator 323. In at least one example embodiment, the apparatus may invoke the program interface element arrangement interaction mode of FIG. 3B from the program invocation interaction mode of FIG. 3A. For example, the apparatus may invoke the program interface element arrangement interaction mode of FIG. 3B based, at least in part, on a program interface element arrangement interaction mode invocation input, such as a long press input in relation to program interface element 301 of FIG. 3A.

In some circumstances, it may be desirable to allow a user to configure data connections between programs by way of performing inputs in relation to program interface elements. For example, the user may readily identify the program interface elements with the programs that they represent. In such an example, the user may quickly understand how their input affects data connections between programs by way of their existing familiarity with the program interface elements. Therefore, in some circumstances, it may be desirable for an apparatus to provide for a program data connection interaction mode.

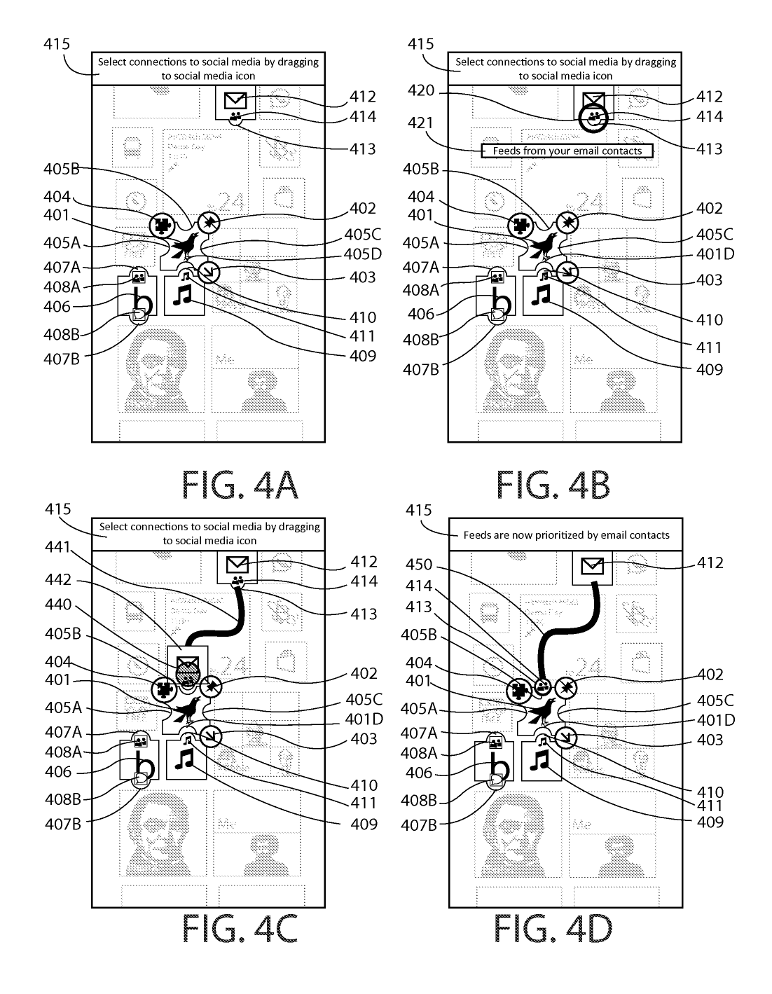

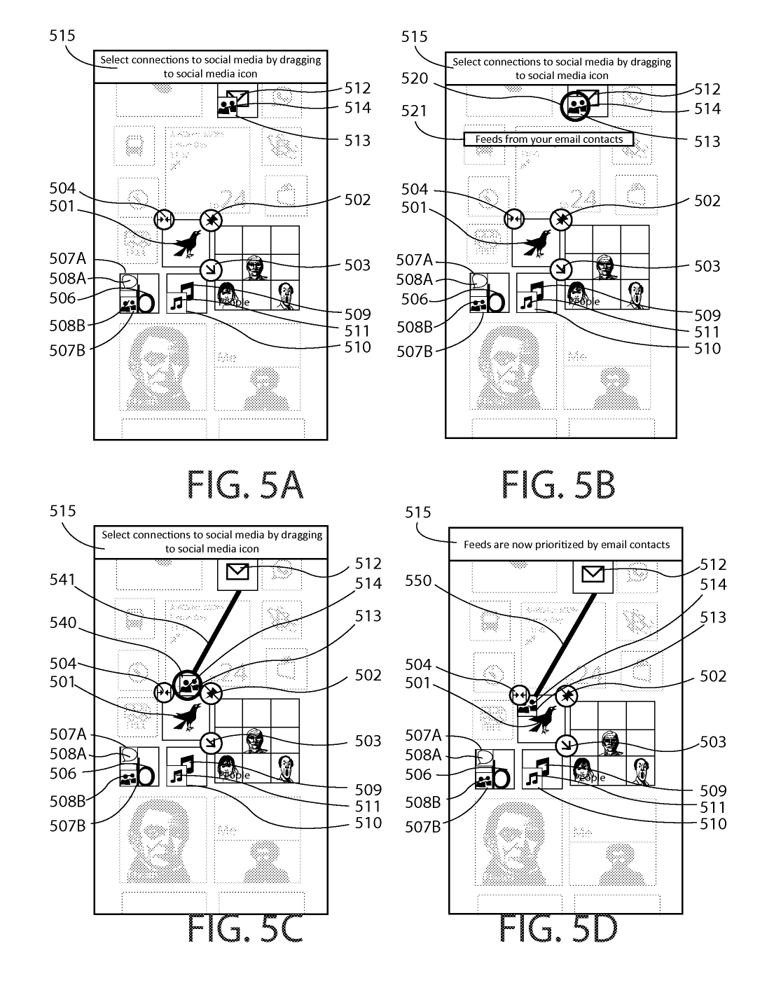

In at least one example embodiment, a program data connection interaction mode is an interaction mode that allows a user to establish, modify, remove, and/or the like, data connections between programs by way of inputs in relation to program interface elements. The program data connection interaction mode may be similar as described regarding FIGS. 4A-4D, FIGS. 5A-5D, and/or the like. In at least one example embodiment, the apparatus may invoke the program data connection interaction mode based, at least in part, on a program data connection interaction mode invocation input. The program data connection interaction mode invocation input may be an input that directs the apparatus to transition from an interaction mode into the program data connection interaction mode.

FIG. 3C is a diagram illustrating a program interface element arrangement interaction mode according to at least one example embodiment. It can be seen that program interface element 341 is larger than other program interface elements. For example, program interface element 341 may have been sized similarly to the program interface element to the left of program interface element 341. In such an example, the apparatus may have increased the size of program interface element 341 to indicate that inputs performed in association with program interface element 341 will cause movement and/or reconfiguration of program interface element 341. However, it should be understood that such size increase may not necessarily result in program interface element 341 being the largest interface element that is being displayed. In this manner, the size of program interface element 341 indicates that inputs performed in association with program interface element 341 will cause movement and/or reconfiguration of program interface element 341. It can be seen that program interface element 341 comprises removal indicator 342, resize indicator 343, and connection mode indicator 344. In at least one example embodiment, the apparatus will cause removal of the program interface element from the display based, at least in part, on an input that corresponds with removal indicator 342. Similarly, the apparatus may cause a change of size of the program interface element based, at least in part, on an input that corresponds with resize indicator 343. In at least one example embodiment, the apparatus invokes a program data connection interaction mode based, at least in part, on an input that corresponds with connection mode indicator 344. In this manner, an input that corresponds with connection mode indicator 344 may be a program data connection interaction mode invocation input. In such an example, the connection mode indicator may be indicative of the program data connection interaction mode of FIGS. 4A-4D.

FIG. 3D is a diagram illustrating a program interface element arrangement interaction mode according to at least one example embodiment. It can be seen that program interface element 361 is larger than other program interface elements. For example, program interface element 361 may have been sized similarly to the program interface element to the left of program interface element 361. In such an example, the apparatus may have increased the size of program interface element 361 to indicate that inputs performed in association with program interface element 361 will cause movement and/or reconfiguration of program interface element 361. However, it should be understood that such size increase may not necessarily result in program interface element 361 being the largest interface element that is being displayed. In this manner, the size of program interface element 361 indicates that inputs performed in association with program interface element 361 will cause movement and/or reconfiguration of program interface element 361. It can be seen that program interface element 361 comprises removal indicator 362, resize indicator 363, and connection mode indicator 364. In at least one example embodiment, the apparatus will cause removal of the program interface element from the display based, at least in part, on an input that corresponds with removal indicator 362. Similarly, the apparatus may cause a change of size of the program interface element based, at least in part, on an input that corresponds with resize indicator 363. In at least one example embodiment, the apparatus invokes a program data connection interaction mode based, at least in part, on an input that corresponds with connection mode indicator 364. In this manner, an input that corresponds with connection mode indicator 364 may be a program data connection interaction mode invocation input. In such an example, the connection mode indicator may be indicative of the program data connection interaction mode of FIGS. 5A-5D.

FIGS. 4A-4D are diagrams illustrating a program data connection interaction mode according to at least one example embodiment. The examples of FIGS. 4A-4D are merely examples and do not limit the scope of the claims. For example, number of program interface elements may vary, representations of indicators may vary, representations of connections may vary, and/or the like.

As previously described, it may be desirable for the apparatus to provide for a program data connection interaction mode that allows a user to cause establishment, modification, disestablishment, and/or the like, of data connections between programs. In at least one example embodiment, the program data connection interaction mode is characterized by inputs causing modification of data connections between one or more programs. In this manner, the program data connection interaction mode is distinct from the program invocation interaction mode. In at least one example embodiment, the program data connection interaction mode is characterized by preclusion of program invocation by way of selection of a program icon. For example, in the program data connection interaction mode, the apparatus may receive information indicative of a program interface element invocation input, and avoid invocation of a program indicated by the program interface element invocation input based, at least in part, on the program data connection interaction mode.

In at least one example embodiment, the apparatus causes termination of the program data connection interaction mode. In at least one example embodiment, the apparatus terminates the program data connection interaction mode by transitioning to a different interaction mode, such as a program invocation interaction mode, a program interface element arrangement interaction mode, and/or the like. In some circumstances, it may be desirable to allow the user to cause termination of the program data connection interaction mode. In at least one example embodiment, the apparatus receives information indicative of a program data connection interaction mode termination input. In such an example, the termination of the program data connection interaction mode may be based, at least in part, on the program data connection interaction mode termination input. The program data connection interaction mode termination input may be any input that conveys a user directive to terminate the program data connection interaction mode. For example, there may be a predetermined input gesture, position, key press, and/or the like that is associated with the program data connection interaction mode termination input.

In the program data connection interaction mode, it may be desirable to allow the user to identify a program interface element of a source program. In at least one example embodiment, a source program interface element is a program interface element that represents a source program. In at least one example embodiment, the apparatus identifies, from a plurality of program interface elements, at least one source program interface element that represents a source program. The apparatus may identify the source program similarly as described regarding FIGS. 2A-2B. In at least one example embodiment, the identification of the source program interface element is based, at least in part, on the initiation of the program data connection interaction mode. For example, the identification of the source program interface element may be caused, at least in part, by the initiation of the program data connection interaction mode.

In at least one example embodiment, the apparatus provides a visual indication that a program interface element is a source program interface element. In at least one example embodiment, the apparatus indicates a source program interface element by way of a data source indicator. In at least one example embodiment, a data source indicator is a visual representation of information that data that the source program may be configured to send to another program. In this manner, the data source indicator may be a visual representation that signifies that a program represented by a program interface element is a source program. In at least one example embodiment, the apparatus causes display of a data source indicator at a position that corresponds with a position of the source program interface element. For example, the data source indicator may be displayed at a position such that the data source indicator is represented as a part of the source program interface element, is a part of the source program interface element, and/or the like.

As previously described, in some circumstances, a source program may send data of a particular data type to another program. In such circumstances, it may be desirable for the user to be able to visually identify a data type of a particular data source indicator. In at least one example embodiment, the data source indicator comprises a data source type indicator that is indicative of a data type of the data source indicator. In at least one example embodiment, the data type of the data source indicator is a data type of data that the apparatus may configure the source program to send to a sink program. The data type indicator may signify contact data, music data, message data, video data, document content data, and/or the like.

As previously described, in some circumstances, the source program may be configurable to send data of multiple data types to another program. In such circumstances, it may be desirable to provide a plurality of data source indicators for the data source. In this manner, the user may be able to distinguish the different data types that may be sent by the source program, may be able to configure different data connections regarding the different data type, and/or the like. In at least one example embodiment, the apparatus determines that the source program is configured to send data of a different data type to one or more programs, and causes display of another data source indicator at a position that corresponds with the position of the source program interface element. In such an example, the other data source indicator may comprise a different data type indicator than that of the data source indicator, which signifies the different data type than the data type of the data source indicator.

In at least one example embodiment, the apparatus identifies, from a plurality of program interface elements, at least one sink program interface element that represents a sink program. The identification of the sink program may be based, at least in part, on an input. For example, if the apparatus invokes the program data connection interaction mode by way of an input associated with connection mode indicator 344 of FIG. 3C, the apparatus may identify program interface element 341 as a sink program interface element. In at least one example embodiment, the identification of the sink program interface element is based, at least in part, on the initiation of the program data connection interaction mode. For example, the identification of the sink program interface element may be caused, at least in part, by the initiation of the program data connection interaction mode.

In at least one example embodiment, the apparatus provides a visual indication that a program interface element is a sink program interface element. In at least one example embodiment, the apparatus indicates a sink program interface element by way of a data sink indicator. In at least one example embodiment, a data sink indicator is a visual representation of information that data that the sink program may be configured to receive from another program. In this manner, the data sink indicator may be a visual representation that signifies that a program represented by a program interface element is a sink program. In at least one example embodiment, the apparatus causes the sink program interface element to comprise a data sink indicator. In at least one example embodiment, the causation of the sink program interface element to comprise the data sink indicator comprises replacement of the sink program interface element with a different sink program interface element that comprises the data sink indicator. In at least one example embodiment, the causation of the sink program interface element to comprise the data sink indicator comprises combination of the data sink indicator with the sink program interface element.

As previously described, in some circumstances, a user may desire to terminate a program data connection interaction mode. In such circumstances, a user may no longer desire to perceive that particular program interface elements represent source programs, represent sink programs, and/or the like. In this manner, the user may desire to cease representations of data source indicators and/or data sink indicators upon termination of the program data connection interaction mode. In at least one example embodiment, the apparatus terminates display of the data source indicator and the data sink indicator based, at least in part, on the termination of a program data connection interaction mode. For example, the apparatus may terminate display of the data source indicator and the data sink indicator based, at least in part, on the initiation of a program invocation interaction mode, the initiation of a program interface element arrangement interaction mode, and/or the like.

In at least one example embodiment, the visual representations of the data source indicators and the data sink indicators conform to a jigsaw puzzle metaphor. In this manner, a user's familiarity with jigsaw puzzles, and the manner in which a protruding portion of a jigsaw puzzle piece is inserted into an indentation in another jigsaw puzzle piece allow the user to readily identify the compatibility of different jigsaw puzzle pieces. It may be desirable to allow the user to relate the data connection relationship between a source program and a sink program by way of the user's familiarity with jigsaw puzzles. In this manner, it may be desirable to represent a data source indicator as a protrusion from the source program interface element and to represent a data sink indicator as an indentation in the sink program interface element. In such an example, the user may be able to readily identify the role of the particular identifiers by way of the jigsaw puzzle metaphor.

In at least one example embodiment, the data sink indicator is a visual representation of an indentation at an edge of the sink program interface element. In at least one example embodiment, a shape of the indentation corresponds with a shape of an edge of the data source indicator. In such an example, the shape of the indentation may correspond with a shape of an edge of the data source indicator such that at least part of the data source indicator fits within the indentation.

In at least one example embodiment, the data source indicator may be positioned such that the data source indicator indicates a protrusion from the source program interface element. In at least one example embodiment, the position of the data source indicator corresponds with a boundary of the source program interface element such that a portion of the data source indicator is within the boundary of the source program interface element and another portion of the data source indicator is beyond the boundary of the source program interface element. In this manner, the other portion of the data source indicator may protrude beyond the boundary of the source program interface element. In at least one example embodiment, the shape of the other portion of the data source indicator corresponds with a shape of an edge of the data sink indicator. In such an example, the shape of the other portion of the data source indicator may correspond with a shape of an edge of the data sink indicator such that at least part of the data source indicator fits within the indentation of the data sink indicator.

FIG. 4A is a diagram illustrating a program data connection interaction mode according to at least one example embodiment. It can be seen that program interface element 401 comprises removal indicator 402, resize indicator 403, and program data connection invocation interface element 404. It can be seen that program interface element 401 is a sink program interface element, for at least the reason that program interface element 401 comprises data sink indicator 405A, data sink indicator 405B, data sink indicator 405C, and data sink indicator 405D. In the example of FIG. 4A, program interface element 406 is a source program interface element, as indicated by data source indicator 407A and data source indicator 407B. It can be seen that data source indicator 407A comprises data type indicator 408A, and that data source indicator 407B comprises data type indicator 408B. In the example of FIG. 4A, program interface element 409 is a source program interface element, as indicated by data source indicator 410. It can be seen that data source indicator 410 comprises data type indicator 411. In the example of FIG. 4A, program interface element 412 is a source program interface element, as indicated by data source indicator 413. It can be seen that data source indicator 413 comprises data type indicator 414.

In some circumstances, the user may desire guidance regarding the effect of the data connection that may be formed by the user's input. In at least one example embodiment, the apparatus causes display of a data connection guidance dialog. The data connection dialog may be information displayed to the user that is communicative of an effect that a particular data connection may have. In the example of FIG. 4A, data connection dialog 415 indicates that the data connection will be associated with the social media program represented by program interface element 401.

As previously described, it may be desirable to allow a user to cause the apparatus to establish a data connection between a source program and a sink program by way of performance of one or more inputs. In this manner, the apparatus may provide a simple and intuitive interface that allows the user to perform inputs in relation to one or more program interface elements, one or more data source indicators, one or more data sink indicators, and/or the like.

In at least one example embodiment, the apparatus receives information indicative of a selection input that occurs at a position that corresponds with a position of the data source indicator. A selection input may be a contact input of a touch input, a button press associated with a cursor, and/or the like. For example, the selection input may be indicative of a user contacting a touch display at a position that corresponds with a position of the data source indicator. In this manner, the selection input may identify the data source indicator for performance of an action based on the touch input.

Upon selection, it may be desirable to allow the user to perform a movement input to indicate a data sink to which the user desires the data source to be connected. In at least one example embodiment, the apparatus receives information indicative of a movement input from the position of the data source indicator to a position of the data sink indicator. The movement input may be a touch input that is subsequent to the contact input of the selection input, absent an intervening absence of contact. In this manner, the movement input may be part of a continuous stroke input that comprises the contact input and the movement input absent a release input. In at least one example embodiment, a release input is a portion of a touch input characterized by removal of contact from the touch sensor, such as lifting a stylus, finger, and/or the like, from the touch display. Similarly, the movement input may be a movement input associated with a cursor and a button press such that the button press is continued from the selection input absent release of the button press. In this manner, the movement input may identify the data sink with which the user desires to form a data connection. In at least one example embodiment, the apparatus receives information indicative of a deselection input that occurs at a position that corresponds with the position of the data sink indicator. The deselection input may be a release input of a touch input, a button release associated with a cursor input, and/or the like.

In some circumstances, it may be desirable for the user to be able to perceive the effect that the input is having on the apparatus. In this manner, the user may desire to understand that the input is causing a data connection from a particular data source, to a particular data sink, and/or the like. In this manner, it may be desirable for the movement input to have a corresponding effect on the information that the apparatus displays so that the user may perceive a visual representation of the data connection, or any part thereof, that the user may be causing. In this manner, the user may desire to perceive movement of the data source indicator that corresponds with the movement input, so that the user may perceive the movement input is effecting the data source represented by the data source indicator.

In at least one example embodiment, the apparatus causes display of another data source indicator at a position that corresponds with a position of the movement input, such that as the position of the movement input changes, the position of the other data source indicator changes to remain in correspondence with the position of the movement input. In such an example, the appearance of the other data source indicator may be the same as the appearance of the data source indicator. In this manner, the user may perceive that the movement input is causing an operation associated with the data source represented by the data source indicator. Upon receipt of the deselection input, the apparatus may terminate display of the data source indicator at the position that corresponds with the position of the source program interface element and cause display of the data source indicator at a position that corresponds with the position of the data sink indicator. In this manner, the release input may cause the appearance that the data source indicator has moved to a position that corresponds with the position of the data sink indicator. This correspondence of position between the data source indicator and the data sink indicator may allow the user to understand that a data connection has been established between the data source represented by the data source indicator and the data sink represented by the data sink indicator.

In some circumstances, the user may desire to perceive further indication of presence of a data connection between programs. In at least one example embodiment, the apparatus causes display of a connection indicator between the source program interface element and the sink program interface element. In some circumstances, the user may desire to perceive an indication of a particular data source that is associated with the sending of data from the source program to the sink program. As previously described, the apparatus may display the data source indicator at a position that corresponds with the sink program interface element, with the data sink indicator, and/or the like. In this manner, the user may desire to perceive which source program interface element is providing the data represented by the data source indicator. In at least one example embodiment, the apparatus causes display of a connection indicator between the source program interface element and the data source indicator.

FIG. 4B is a diagram illustrating a program data connection interaction mode according to at least one example embodiment. In the example of FIG. 4B, the apparatus receives a selection input denoted by position 420. It can be seen that position 420 corresponds with the position of data source indicator 413.

In some circumstances, the user may desire guidance regarding the effect of the data connection that may be formed by the user's input in relation to the selected data source indicator. In at least one example embodiment, the apparatus causes display of another data connection guidance dialog. The other data connection dialog may be information displayed to the user that is communicative of an effect that a particular data connection may have regarding the selected data source indicator. In the example of FIG. 4B, data connection dialog 421 indicates that the data connection will cause the social media application to a prioritize feeds from the social media program that corresponds with the contact data received by way of the data source represented by data source indicator 413.

FIG. 4C is a diagram illustrating a program data connection interaction mode according to at least one example embodiment. In the example of FIG. 4C, the apparatus has received a movement input from position 420 shown in FIG. 4B, to position 440. It can be seen that the apparatus has caused display of program interface element 442. It can be seen that the appearance of program interface element is the same as the appearance of program interface element 412. It can also be seen that the position of program interface element 442 is displayed at position 440, in correspondence with the movement input. In the example of FIG. 4C, the apparatus has caused display of data connection indicator 441 that extends from program interface element 412 to program interface element 442. In this manner, the user may perceive that program interface element 442 is directly related to program interface element 412.

FIG. 4D is a diagram illustrating a program data connection interaction mode according to at least one example embodiment. In the example of FIG. 4D, the apparatus has received a deselection input at a position that corresponds with data sink indicator 405B, subsequent to the movement input to the position of data sink indicator 405B. It can be seen that the apparatus has terminated display of program interface element 442. In the example of FIG. 4D, the apparatus has terminated display of data source indicator 414 at a position that corresponds with program interface element 412, and has caused display of data source indicator 413 at a position that corresponds with data sink indicator 405B. In this manner, the user may understand that the program represented by program interface element 412 may be configured to send data that is associated with data source indicator 413 to the program represented by program interface element 401. In the example of FIG. 4D, the apparatus has caused display of data connection indicator 450, which extends from program interface element 412 to data source indicator 413. In this manner, data connection indicator 450 allows the user to understand that the program represented by program interface element 412 may be configured to send data that is associated with data source indicator 413 to the program represented by program interface element 401.

In the example of FIG. 4D, data connection dialog 415 has been changed to indicate the effect of the data connection that may have been established by way of the received inputs. It can be seen that data connection dialog 415 indicates that the data connection will cause the social media application to a prioritize feeds from the social media program that corresponds with the contact data received by way of the data source represented by data source indicator 413.

FIGS. 5A-5D are diagrams illustrating a program data connection interaction mode according to at least one example embodiment. The examples of FIGS. 5A-5D are merely examples and do not limit the scope of the claims. For example, number of program interface elements may vary, representations of indicators may vary, representations of connections may vary, and/or the like.

In some circumstance, it may be desirable for the user to perceive data connection by way of an overlay metaphor. For example, the user may perceive relationships between data sources and data sinks by way of a representation that indicates relationships by way of overlaying data source indicators on an associated source program interface element, on a sink program interface element to which the data source is connected, and/or the like. In at least one example embodiment, the position of the data source indicator is such that an entirety of the data source indicator is within a boundary of the source program interface element. In this manner, the data source indicator may overlay the source program interface element. The examples of FIGS. 5A-5D illustrate an example associated with an overlay metaphor.

In some circumstances, the user may be able to identify a program interface element as a sink program interface element by way of the program interface element comprising a program data connection invocation interface element. For example, the apparatus may preclude display of a program data connection invocation interface element at a position that corresponds with the position of the program interface element if the program represented by the program interface element is incapable of being configured to receive data from another program. In this manner, the program data connection invocation interface element may be a data sink indicator. As such, the data sink indicator may be a program data connection invocation interface element. In at least one example embodiment, the data sink indicator is a program data connection invocation interface element comprised by the sink program interface element.

FIG. 5A is a diagram illustrating a program data connection interaction mode according to at least one example embodiment. It can be seen that program interface element 501 comprises removal indicator 502, resize indicator 503, and program data connection invocation interface element 504. It can be seen that program interface element 501 is a sink program interface element, for at least the reason that program interface element 501 comprises program data connection invocation interface element 504. In the example of FIG. 5A, program interface element 506 is a source program interface element, as indicated by data source indicator 507A and data source indicator 507B. It can be seen that data source indicator 507A comprises data type indicator 508A, and that data source indicator 507B comprises data type indicator 508B. In the example of FIG. 5A, program interface element 509 is a source program interface element, as indicated by data source indicator 510. It can be seen that data source indicator 510 comprises data type indicator 511. In the example of FIG. 5A, program interface element 512 is a source program interface element, as indicated by data source indicator 513. It can be seen that data source indicator 513 comprises data type indicator 514. In the example of FIG. 5A, data connection dialog 515 indicates that the data connection will be associated with the social media program represented by program interface element 501.

FIG. 5B is a diagram illustrating a program data connection interaction mode according to at least one example embodiment. In the example of FIG. 5B, the apparatus receives a selection input denoted by position 520. It can be seen that position 520 corresponds with the position of data source indicator 513. In the example of FIG. 5B, data connection dialog 521 indicates that the data connection will cause the social media application to a prioritize feeds from the social media program that corresponds with the contact data received by way of the data source represented by data source indicator 513.

FIG. 5C is a diagram illustrating a program data connection interaction mode according to at least one example embodiment. In the example of FIG. 5C, the apparatus has received a movement input from position 520 shown in FIG. 5B, to position 540. It can be seen that the apparatus has caused display of data source indicator 513 to be moved to a position that corresponds with position 540, in correspondence with the movement input. In the example of FIG. 5C, the apparatus has caused display of data connection indicator 541 that extends from program interface element 512 to data source indicator 513. In this manner, the user may perceive that program interface element 512 is directly related to data source indicator 513.

FIG. 5D is a diagram illustrating a program data connection interaction mode according to at least one example embodiment. In the example of FIG. 5D, the apparatus has received a deselection input at a position that corresponds with program interface element 501, subsequent to the movement input to the position of program interface element 501. In the example of FIG. 5D, the apparatus has caused display of data source indicator 513 at a position that corresponds with program interface element 501. In this manner, the user may understand that the program represented by program interface element 512 may be configured to send data that is associated with data source indicator 513 to the program represented by program interface element 501. In the example of FIG. 5D, the apparatus has caused display of data connection indicator 550, which extends from program interface element 512 to data source indicator 513. In this manner, data connection indicator 550 allows the user to understand that the program represented by program interface element 512 may be configured to send data that is associated with data source indicator 513 to the program represented by program interface element 501.

In the example of FIG. 5D, data connection dialog 515 has been changed to indicate the effect of the data connection that may have been established by way of the received inputs. It can be seen that data connection dialog 515 indicates that the data connection will cause the social media application to a prioritize feeds from the social media program that corresponds with the contact data received by way of the data source represented by data source indicator 513.

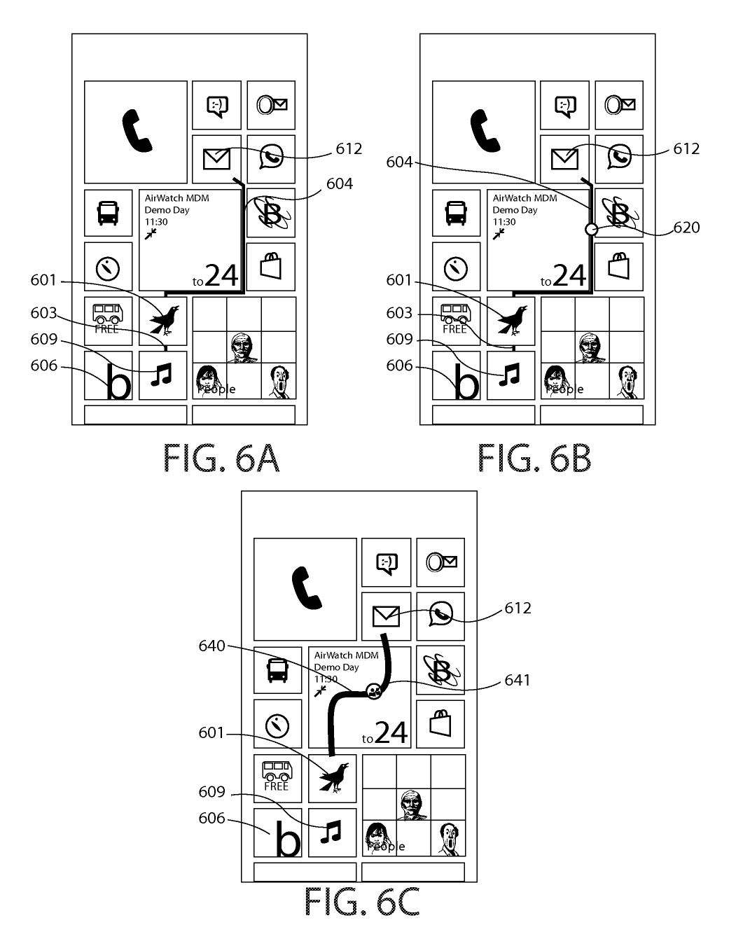

FIGS. 6A-6C are diagrams illustrating a connection indicator according to at least one example embodiment. The examples of FIGS. 6A-6C are merely examples and do not limit the scope of the claims. For example, representation of the connection indicator may vary, arrangement of program interface elements may vary, path of connection indicator may vary, and/or the like.

In some circumstances, a user may desire to perceive data connections during a program invocation interaction mode. For example, the user may desire to perceive how many programs may have data connections, which programs have data connections, and or the like. In at least one example embodiment, the apparatus determines existence of a data connection between a source program and a sink program, and causes display of a connection indicator between the source program interface element and the sink program interface element based, at least in part, on the data connection. It should be understood that there are many manners that the connection indicator may be represented and that the manner in which the connection indicator is represented does not necessarily limit the claims. In at least one example embodiment, the connection indicator is a line that has an endpoint at a position that corresponds with the position of the source program interface element and another endpoint at a position that corresponds with the position of the sink program interface element.

FIG. 6A is a diagram illustrating a connection indicator according to at least one example embodiment. In the example of FIG. 6A, the apparatus has determined that a data connection exists between the program represented by program interface element 612 and the program represented by program interface element 601, and that a data connection exists between the program represented by program interface element 609 and the program represented by program interface element 601. In the example of FIG. 6A, the apparatus has caused display of connection indicator 604, which extends between program interface element 612 and program interface element 601. In the example of FIG. 6A, the apparatus has caused display of connection indicator 603, which extends between program interface element 609 and program interface element 601.

In some circumstances, a user may desire to perceive that data is being transferred from a program to another program. In such an example, it may be desirable to represent the transfer of data from a source program to a sink program by way of an animation along the connection indicator. In at least one example embodiment, the apparatus causes display of an animation in relation to the connection indicator that is indicative of the source program sending the data to the sink program. It should be understood that there are many manners in which the animation may indicate the source program sending data to the sink program and that the manner in which the animation may indicate the source program sending data to the sink program does not necessarily limit the claims.

In at least one example embodiment, the animation comprises movement of one or more colored bands along the connection indicator in a direction from the source program interface element to the sink program interface element. In this manner, the progression of the colored bands may indicate that data is being transferred, and the direction of the progression may indicate the direction of the transfer of the data.

In at least one example embodiment, the animation comprises movement of a data indicator along the connection indicator in a direction from the source program interface element to the sink program interface element. The data indicator may be a shape that extends beyond the width of the connection indicator. In this manner, the progression of the data indicator may indicate that data is being transferred, and the direction of the progression may indicate the direction of the transfer of the data.

FIG. 6B is a diagram illustrating a connection indicator according to at least one example embodiment. In the example of FIG. 6B, the apparatus has determined that the program represented by program interface element 612 is sending data to the program represented by program interface element 601. In the example of FIG. 6B, the apparatus is causing display of an animation that comprises movement of data indicator 620 along connection indicator 604 in a direction from program interface element 612 to program interface element 601. It can be seen that data indicator 620 is a circle that extends beyond the width of connection indicator 604.

In some circumstances, the user may desire to understand the type of data that is being sent between programs. In at least one example embodiment, the data indicator comprises a data type indicator.

FIG. 6C is a diagram illustrating a connection indicator according to at least one example embodiment. In the example of FIG. 6C, connection indicator 640 represents a data connection between the program represented by program interface element 612 and the program represented by program interface element 601. In the example of FIG. 6C, the apparatus has determined that the program represented by program interface element 612 is sending data to the program represented by program interface element 601. In the example of FIG. 6C, the apparatus is causing display of an animation that comprises movement of data indicator 641 along connection indicator 640 in a direction from program interface element 612 to program interface element 601. It can be seen that data indicator 641 is a circle that extends beyond the width of connection indicator 640, and comprises a data type indicator that represents contact data.

In some circumstances, the user may desire to obtain more details on the data which is being moved. In such circumstances, the user could select or otherwise interact with a data type indicator and/or data movement indicator. In such an example, the apparatus may indicate an example of concrete data items, such as e-mail contact names, which are being transferred from the source program to the sink program.

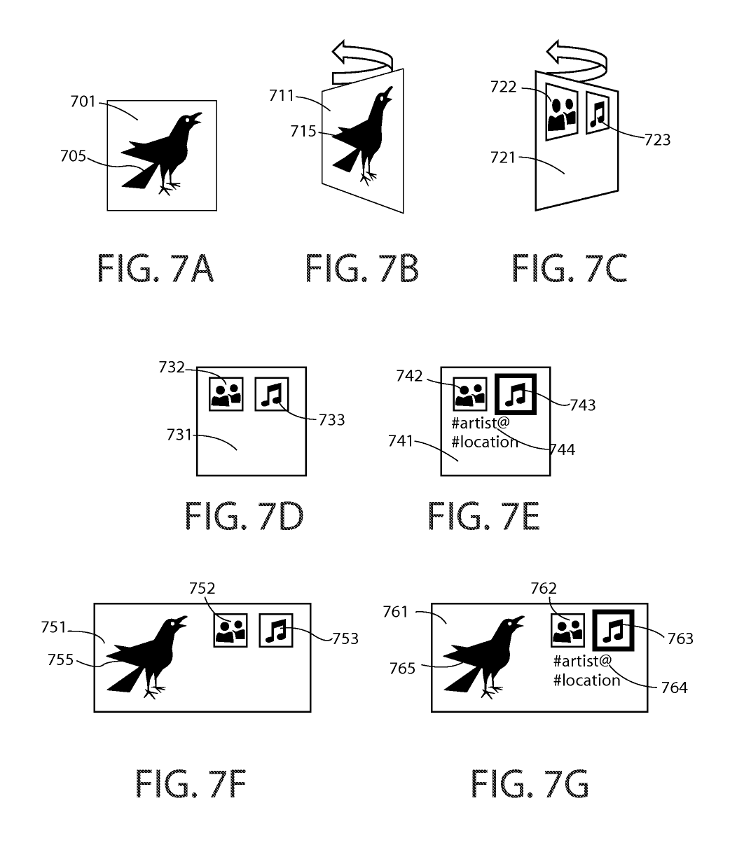

FIGS. 7A-7G are diagrams illustrating a program interface element according to at least one example embodiment. The examples of FIGS. 7A-7G are merely examples and do not limit the scope of the claims. For example, proportions of the program interface element may vary, orientation of the program interface element may vary, arrangement of indicators may vary, and/or the like.

In some circumstances a user may desire to perceive which data sources are associated with a particular program. For example, the user may desire to understand from which data sources a program is configured to receive data. In some circumstances, the user may desire to perceive such configuration during a program invocation interaction mode.

In at least one example embodiment, the apparatus determines that a data connection exists between a source program and a sink program, and causes the sink program interface element to comprise a data source indicator based, at least in part, on the data connection between the source program and the sink program. In at least one example embodiment, the sink program interface element comprises the data source indicator such that the data source indicator is represented by way of an animation of the sink program interface element being flipped from a represented surface of the sink program interface element to present a different represented surface of the sink program interface element that comprises the data source indicator.

FIGS. 7A-7E illustrate an animation of the sink program interface element according to at least one example embodiment. It can be seen that program interface element 701 comprises image 705. In the example of FIG. 7A, program interface element is a non-flipped representation. In FIG. 7B, it can be seen that program interface element 711 is a representation at a later part of the animation such that program interface element 711 represents a graphical transformation of program interface element 701 in a depth-wise rotation that is indicative of the program interface element being flipped. In FIG. 7B, it can be seen that image 715 is a representation at a later part of the animation such that image 715 represents a graphical transformation of image 705 in a depth-wise rotation that is indicative of the program interface element being flipped.

In FIG. 7C, it can be seen that program interface element 721 is a representation at a later part of the animation such that program interface element 721 represents a graphical transformation of program interface element 701 in a depth-wise rotation that is indicative of the program interface element being flipped. It the example of FIG. 7C, the program interface element has flipped to an extent such that a representation opposite side of the program interface element may be shown. In this manner, data source indicator 722 and data source indicator 723 may be displayed in relation to a represented opposite side of the program interface element.

In FIG. 7D, it can be seen that program interface element 731 is a representation at a later part of the animation such that program interface element 731 represents a graphical transformation of program interface element 701 in a depth-wise rotation that is indicative of the program interface element being flipped. It the example of FIG. 7D, the program interface element has flipped to an extent such that a representation opposite side of the program interface element may be shown. In this manner, data source indicator 732 is a transformed version of data source indicator 723, and data source indicator 733 is a transformed version of data source indicator 722.

In some circumstances, the user may desire to perceive information indicative of data that is being received by the sink program, that has been received by the sink program, and/or the like. In at least one example embodiment, the apparatus causes the sink program interface element to comprise a data element indicator that represents the data that was sent from the source program to the sink program. In at least one example embodiment, the sink program interface element comprises the data element indicator such that the data source indicator is represented by way of an animation of the sink program interface element being flipped from a represented surface of the sink program interface element to present a different represented surface of the sink program interface element that comprises the data element indicator.

FIG. 7E is a diagram illustrating a program interface element according to at least one example embodiment. The example of FIG. 7E illustrates an example of a representation opposite side of program interface element 701. In the example of FIG. 7E, data source indicator 742 and data source indicator 743 are displayed in relation to a represented opposite side of the program interface element. In the example of FIG. 7E, data element indicator 744 is displayed in relation to a represented opposite side of the program interface element. It can be seen that data element indicator 744 represents artist data and location data that has been sent to the program represented by program interface element 741.

In some circumstances, the user may desire to perceive a data source that is connected to the program represented by a program interface element, even in the absence of an animation. For example, the apparatus may cause the program interface element to comprise one or more data source indicators, to comprise one or more data element indicators, and/or the like. In some circumstances, a larger version of the program interface element may comprise the data source indicator absent animation, and a smaller version of the program interface element may comprise the data source indicator by way of animation.

FIG. 7F is a diagram illustrating a program interface element according to at least one example embodiment. It can be seen that program interface element 751 comprises image 755, data source indicator 752, and data source indicator 753.

FIG. 7G is a diagram illustrating a program interface element according to at least one example embodiment. It can be seen that program interface element 761 comprises image 765, data source indicator 762, data source indicator 763, and data element indicator 764.

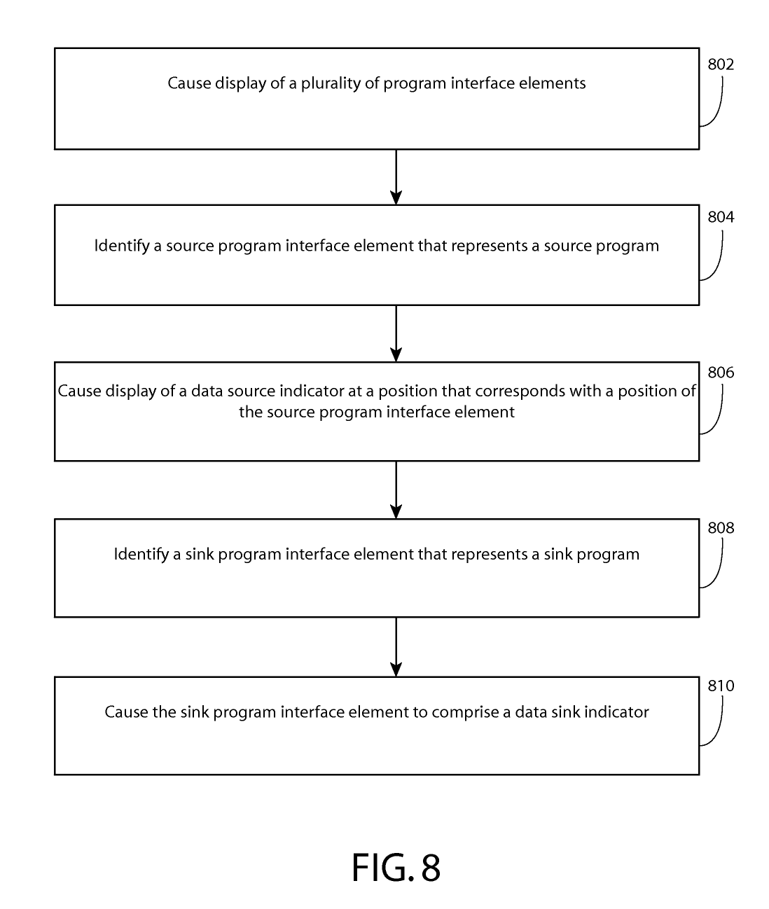

FIG. 8 is a flow diagram illustrating activities associated with program data connection indication according to at least one example embodiment. In at least one example embodiment, there is a set of operations that corresponds with the activities of FIG. 8. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 8.

At block 802, the apparatus causes display of a plurality of program interface elements. The program interface elements may be similar as described regarding FIGS. 3A-3D.

At block 804, the apparatus identifies, from the plurality of program interface elements, of at least one source program interface element that represents a source program. The identification, the source program interface element and the source program may be similar as described regarding FIGS. 2A-2B, FIGS. 3A-3D, FIGS. 4A-4D, and FIGS. 5A-5D.

At block 806, the apparatus causes display of a data source indicator at a position that corresponds with a position of the source program interface element. The data source indicator and the positions may be similar as described regarding FIGS. 3A-3D, FIGS. 4A-4D, and FIGS. 5A-5D.

At block 808, the apparatus identifies, from the plurality of program interface elements, of at least one sink program interface element that represents a sink program. The identification, the sink program interface element, and the sink program may be similar as described regarding FIGS. 2A-2B, FIGS. 3A-3D, FIGS. 4A-4D, and FIGS. 5A-5D.

At block 810, the apparatus causes the sink program interface element to comprise a data sink indicator. The causation and the sink data indicator may be similar as described regarding FIGS. 4A-4D and FIGS. 5A-5D.

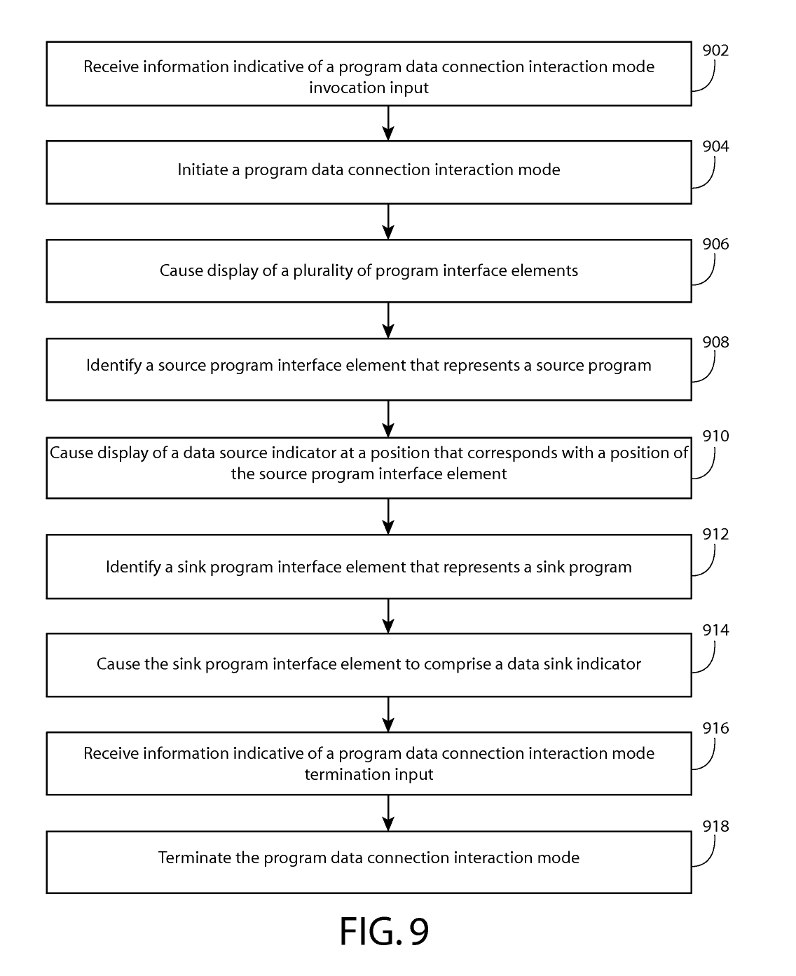

FIG. 9 is a flow diagram illustrating activities associated with program data connection indication according to at least one example embodiment. In at least one example embodiment, there is a set of operations that corresponds with the activities of FIG. 9. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 9.

As previously described, the apparatus may provide for a program data connection interaction mode. In such an example, the display of the data source indicator and the data sink indicator may be based, at least in part, on the apparatus being in the program data connection interaction mode.

At block 902, the apparatus receives information indicative of a program data connection interaction mode invocation input. The program data connection interaction mode invocation input may be similar as described regarding FIGS. 3A-3D.

At block 904, the apparatus initiates a program data connection interaction mode based, at least in part, on the program data connection interaction mode invocation input. The initiation and the program data connection interaction mode may be similar as described regarding FIGS. 4A-4D and FIGS. 5A-5D.

At block 906, the apparatus causes display of a plurality of program interface elements, similarly as described regarding block 802 of FIG. 8. At block 908, the apparatus identifies, from the plurality of program interface elements, of at least one source program interface element that represents a source program, similarly as described regarding block 804 of FIG. 8. At block 910, the apparatus causes display of a data source indicator at a position that corresponds with a position of the source program interface element, similarly as described regarding block 806 of FIG. 8. At block 912, the apparatus identifies, from the plurality of program interface elements, of at least one sink program interface element that represents a sink program, similarly as described regarding block 808 of FIG. 8. At block 914, the apparatus causes the sink program interface element to comprise a data sink indicator, similarly as described regarding block 810 of FIG. 8.

At block 916, the apparatus receives information indicative of a program data connection interaction mode termination input. The receipt and the program data connection interaction mode termination input may be similar as described regarding FIGS. 4A-4D and FIGS. 5A-5D.

At block 918, the apparatus terminates the program data connection interaction mode based, at least in part, on the program data connection interaction mode termination input. The termination may be similar as described regarding FIGS. 4A-4D and FIGS. 5A-5D.

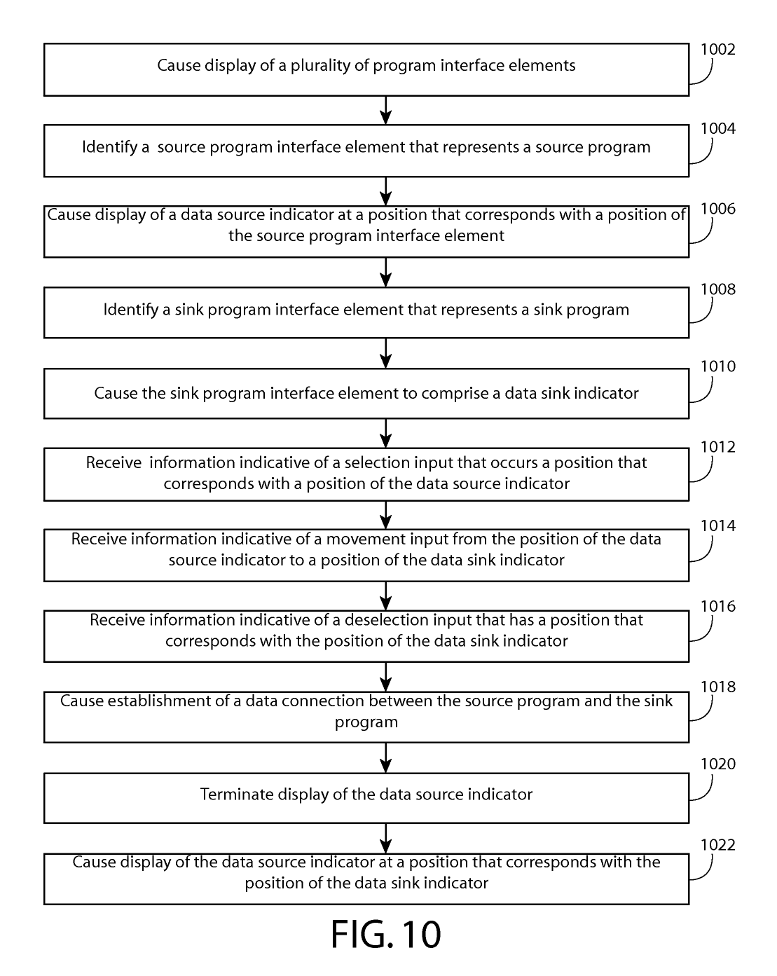

FIG. 10 is a flow diagram illustrating activities associated with program data connection indication according to at least one example embodiment. In at least one example embodiment, there is a set of operations that corresponds with the activities of FIG. 10. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 10.

As previously described, it may be desirable to allow the user to cause establishment of a data connection between programs by way of performance of inputs in relation to a data source indicator. In such circumstances, it may further be desirable to indicate that the data connection has been established.

At block 1002, the apparatus causes display of a plurality of program interface elements, similarly as described regarding block 802 of FIG. 8. At block 1004, the apparatus identifies, from the plurality of program interface elements, of at least one source program interface element that represents a source program, similarly as described regarding block 804 of FIG. 8. At block 1006, the apparatus causes display of a data source indicator at a position that corresponds with a position of the source program interface element, similarly as described regarding block 806 of FIG. 8. At block 1008, the apparatus identifies, from the plurality of program interface elements, of at least one sink program interface element that represents a sink program, similarly as described regarding block 808 of FIG. 8. At block 1010, the apparatus causes the sink program interface element to comprise a data sink indicator, similarly as described regarding block 810 of FIG. 8.

At block 1012, the apparatus receives information indicative of a selection input that occurs at a position that corresponds with a position of the data source indicator. The receipt, the selection input, and the positions may be similar as described regarding FIGS. 4A-4D and FIGS. 5A-5D.

At block 1014, the apparatus receives information indicative of a movement input from the position of the data source indicator to a position of the data sink indicator. The receipt, the movement input, and the positions may be similar as described regarding FIGS. 4A-4D and FIGS. 5A-5D.

At block 1016, the apparatus receives information indicative of a deselection input that occurs at a position that corresponds with the position of the data sink indicator. The receipt, the deselection input, and the positions may be similar as described regarding FIGS. 4A-4D and FIGS. 5A-5D.

At block 1018, the apparatus causes establishment of a data connection between the source program and the sink program based, at least in part, on the selection input, the movement input, and the deselection input. The establishment and the data connection may be similar as described regarding FIGS. 2A-2B.

At block 1020, the apparatus terminates display of the data source indicator at the position that corresponds with the position of the source program interface element. The termination may be similar as described regarding FIGS. 4A-4D and FIGS. 5A-5D.

At block 1022, the apparatus causes display of the data source indicator at a position that corresponds with the position of the data sink indicator. The causation of display and the positions may be similar as described regarding FIGS. 4A-4D and FIGS. 5A-5D.

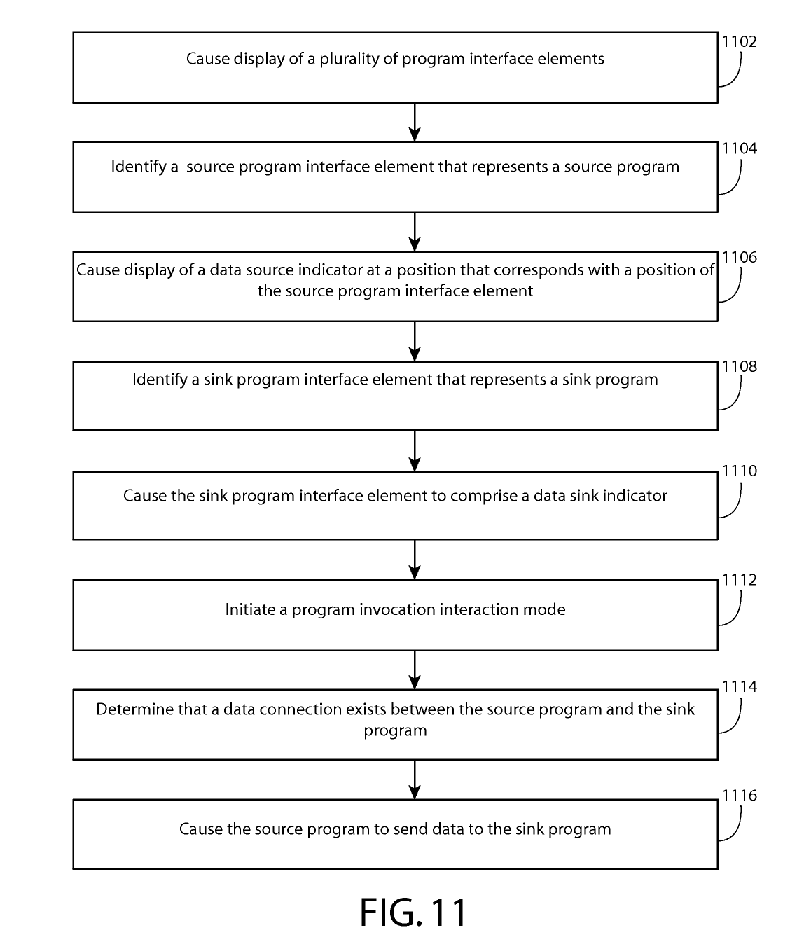

FIG. 11 is a flow diagram illustrating activities associated with program data connection indication according to at least one example embodiment. In at least one example embodiment, there is a set of operations that corresponds with the activities of FIG. 11. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 11.

As previously described, it may be desirable for a source program to send data to a sink program based on the data connection between the source program and the sink program.

At block 1102, the apparatus causes display of a plurality of program interface elements, similarly as described regarding block 802 of FIG. 8. At block 1104, the apparatus identifies, from the plurality of program interface elements, of at least one source program interface element that represents a source program, similarly as described regarding block 804 of FIG. 8. At block 1106, the apparatus causes display of a data source indicator at a position that corresponds with a position of the source program interface element, similarly as described regarding block 806 of FIG. 8. At block 1108, the apparatus identifies, from the plurality of program interface elements, of at least one sink program interface element that represents a sink program, similarly as described regarding block 808 of FIG. 8. At block 1110, the apparatus causes the sink program interface element to comprise a data sink indicator, similarly as described regarding block 810 of FIG. 8.

At block 1112, the apparatus initiates a program invocation interaction mode. The program invocation interaction mode may be similar as described regarding FIGS. 3A-3D.

At block 1114, the apparatus determines that a data connection exists between the source program and the sink program. The determination may be similar as described regarding FIGS. 2A-2B.

At block 1116, the apparatus causes the source program to send data to the sink program based, at least in part, on the data connection between the source program and the sink program. The sending may be similar as described regarding FIGS. 2A-2B.

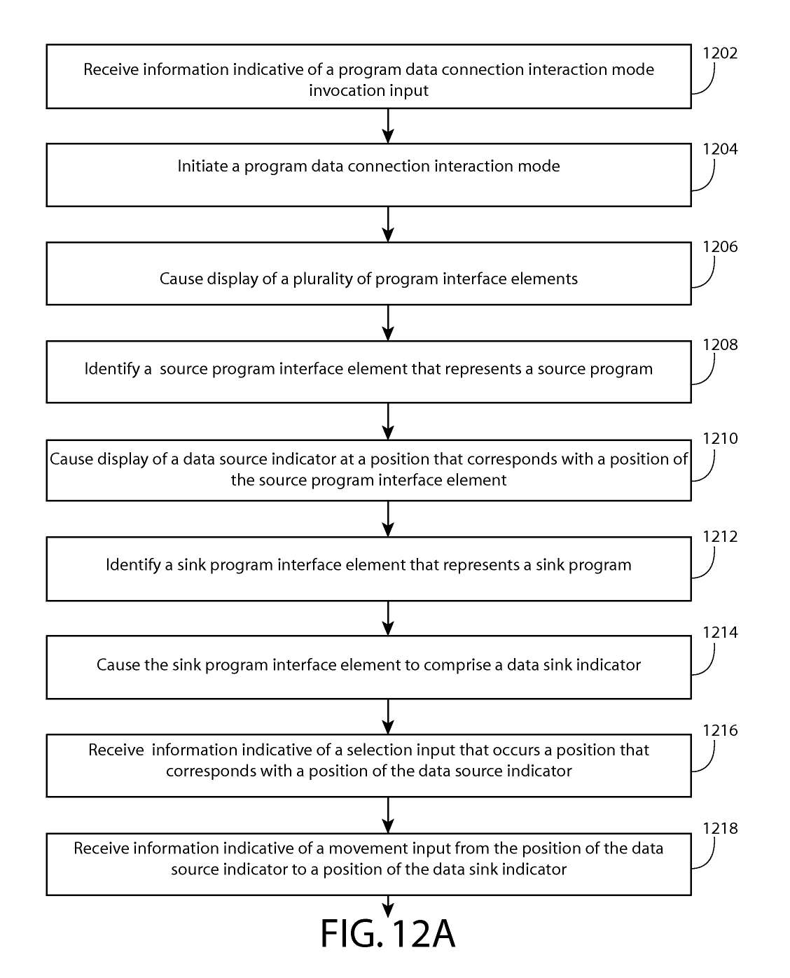

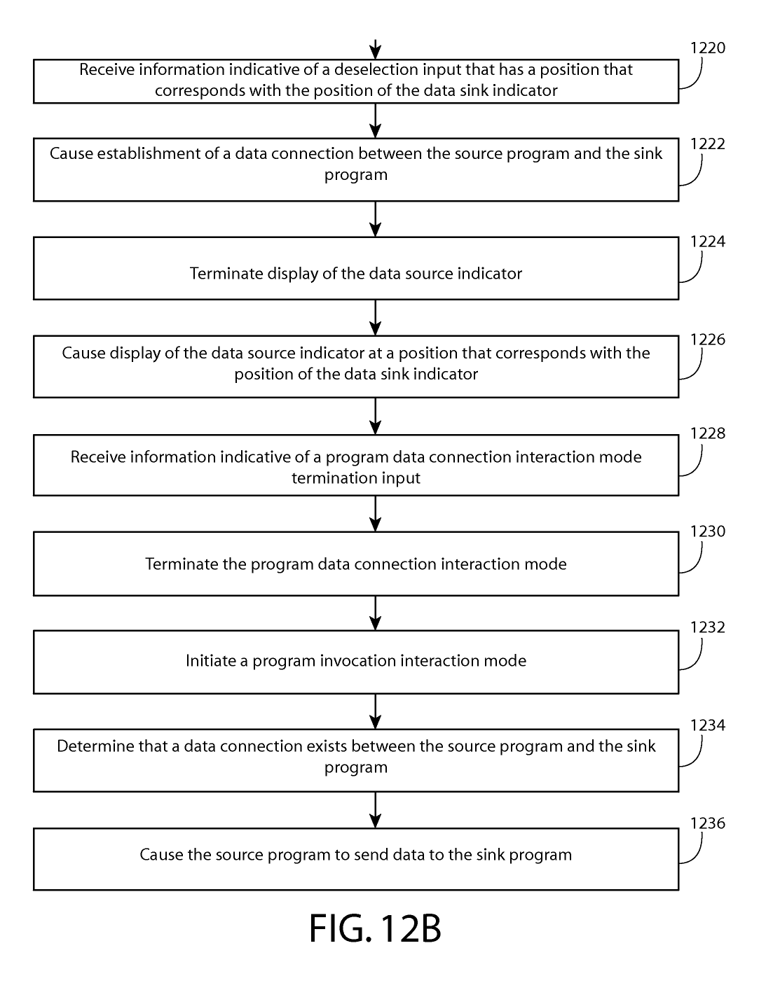

FIGS. 12A and 12B are a flow diagram illustrating activities associated with program data connection indication according to at least one example embodiment. In at least one example embodiment, there is a set of operations that corresponds with the activities of FIGS. 12A and 12B. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIGS. 12A and 12B.

It should be understood that various aspects described herein may be combined in various manners. The example of FIGS. 12A and 12B provides an example of various aspects of the subject matter described herein operating in conjunction with each other.

At block 1202, the apparatus the apparatus receives information indicative of a program data connection interaction mode invocation input, similarly as described regarding block 902 of FIG. 9. At block 1204, the apparatus initiates a program data connection interaction mode based, at least in part, on the program data connection interaction mode invocation input, similarly as described regarding block 904 of FIG. 9.

At block 1206, the apparatus causes display of a plurality of program interface elements, similarly as described regarding block 802 of FIG. 8. At block 1208, the apparatus identifies, from the plurality of program interface elements, of at least one source program interface element that represents a source program, similarly as described regarding block 804 of FIG. 8. At block 1210, the apparatus causes display of a data source indicator at a position that corresponds with a position of the source program interface element, similarly as described regarding block 806 of FIG. 8. At block 1212, the apparatus identifies, from the plurality of program interface elements, of at least one sink program interface element that represents a sink program, similarly as described regarding block 808 of FIG. 8. At block 1214, the apparatus causes the sink program interface element to comprise a data sink indicator, similarly as described regarding block 810 of FIG. 8.

At block 1216, the apparatus receives information indicative of a selection input that occurs at a position that corresponds with a position of the data source indicator, similarly as described regarding block 1012 of FIG. 10. At block 1218, the apparatus receives information indicative of a movement input from the position of the data source indicator to a position of the data sink indicator, similarly as described regarding block 1014 of FIG. 10. At block 1220, the apparatus receives information indicative of a deselection input that occurs at a position that corresponds with the position of the data sink indicator, similarly as described regarding block 1016 of FIG. 10. At block 1222, the apparatus causes establishment of a data connection between the source program and the sink program based, at least in part, on the selection input, the movement input, and the deselection input, similarly as described regarding block 1018 of FIG. 10. At block 1224, the apparatus terminates display of the data source indicator at the position that corresponds with the position of the source program interface element, similarly as described regarding block 1020 of FIG. 10. At block 1226, the apparatus causes display of the data source indicator at a position that corresponds with the position of the data sink indicator, similarly as described regarding block 1022 of FIG. 10.

At block 1228, the apparatus receives information indicative of a program data connection interaction mode termination input, similarly as described regarding block 916 of FIG. 9. At block 1230, the apparatus terminates the program data connection interaction mode based, at least in part, on the program data connection interaction mode termination input, similarly as described regarding block 918 of FIG. 9.

At block 1232, the apparatus initiates a program invocation interaction mode, similarly as described regarding block 1112 of FIG. 11. At block 1234, the apparatus determines that a data connection exists between the source program and the sink program, similarly as described regarding block 1114 of FIG. 11. At block 1236, the apparatus causes the source program to send data to the sink program based, at least in part, on the data connection between the source program and the sink program, similarly as described regarding block 1116 of FIG. 11.

Embodiments of the invention may be implemented in software, hardware, application logic or a combination of software, hardware, and application logic. The software, application logic and/or hardware may reside on the apparatus, a separate device, or a plurality of separate devices. If desired, part of the software, application logic and/or hardware may reside on the apparatus, part of the software, application logic and/or hardware may reside on a separate device, and part of the software, application logic and/or hardware may reside on a plurality of separate devices. In an example embodiment, the application logic, software or an instruction set is maintained on any one of various conventional computer-readable media.

If desired, the different functions discussed herein may be performed in a different order and/or concurrently with each other. For example, block 806 of FIG. 8 may be performed after block 808 of FIG. 8. Furthermore, if desired, one or more of the above-described functions may be optional or may be combined. For example, block 804 of FIG. 8 may be optional and/or combined with block 808 of FIG. 8.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are variations and modifications which may be made without departing from the scope of the present invention as defined in the appended claims.

What is claimed is:

1. An apparatus, comprising:
at least one processor;
at least one memory including computer program code, the memory and the computer program code configured to, working with the processor, cause the apparatus to perform at least the following:
causation of display of a plurality of program interface elements;
identification, from the plurality of program interface elements, of at least one source program interface element that represents a source program, the source program being a program that is configured to send data to one or more programs;
causation of display of a data source indicator at a position that corresponds with a position of the source program interface element;
identification, from the plurality of program interface elements, of at least one sink program interface element that represents a sink program, the sink program being a program that is configured to receive data from one or more programs; and
causation of the sink program interface element to comprise a data sink indicator.

2. The apparatus of claim 1, wherein the memory includes computer program code configured to, working with the processor, cause the apparatus to perform initiation of a program data connection interaction mode, wherein the identification of the source program interface element is based, at least in part, on the initiation of the program data connection interaction mode.

3. The apparatus of claim 2, wherein the memory includes computer program code configured to, working with the processor, cause the apparatus to perform:
receipt of information indicative of a program data connection interaction mode invocation input, wherein the initiation of the program data connection interaction mode is based, at least in part, on the program data connection interaction mode invocation input;
receipt of information indicative of a program data connection interaction mode termination input; and
termination of the program data connection interaction mode based, at least in part, on the program data connection interaction mode termination input.

4. The apparatus of claim 1, wherein the data sink indicator is a visual representation of an indentation at an edge of the sink program interface element such that a shape of the indentation corresponds with a shape of an edge of the data source indicator.

5. The apparatus of claim 1, wherein the position of the data source indicator corresponds with a boundary of the source program interface element such that a portion of the data source indicator is within the boundary of the source program interface element and another portion of the data source indicator is beyond the boundary of the source program interface element, such that a shape of the other portion of the data source indicator corresponds with a shape of an edge of the data sink indicator.

6. The apparatus of claim 1, wherein the memory includes computer program code configured to, working with the processor, cause the apparatus to perform:
receipt of information indicative of a selection input that occurs at a position that corresponds with a position of the data source indicator;
receipt of information indicative of a movement input from the position of the data source indicator to a position of the data sink indicator;
receipt of information indicative of a deselection input that occurs at a position that corresponds with the position of the data sink indicator;
causation of establishment of a data connection between the source program and the sink program based, at least in part, on the selection input, the movement input, and the deselection input;
termination of display of the data source indicator at the position that corresponds with the position of the source program interface element; and
causation of display of the data source indicator at a position that corresponds with the position of the data sink indicator.

7. The apparatus of claim 1, wherein the memory includes computer program code configured to, working with the processor, cause the apparatus to perform:
initiation of a program invocation interaction mode;
determination that a data connection exists between the source program and the sink program;
causation of the source program to send data to the sink program based, at least in part, on the data connection between the source program and the sink program;
causation of display of a connection indicator between the source program interface element and the sink program interface element based, at least in part, on the data connection; and
causation of display of an animation in relation to the connection indicator that is indicative of the source program sending the data to the sink program.

8. The apparatus of claim 7, wherein the memory includes computer program code configured to, working with the processor, cause the apparatus to perform:
termination of display of the data source indicator and the data sink indicator based, at least in part, on the initiation of a program invocation interaction mode;
causation of the sink program interface element to comprise a data source indicator based, at least in part, on the data connection between the source program and the sink program, wherein the sink program interface element comprises the data source indicator such that the data source indicator is represented by way of an animation of the sink program interface element being flipped from a represented surface of the sink program interface element to present a different represented surface of the sink program interface element that comprises the data source indicator.

9. The apparatus of claim 1, wherein the apparatus comprises a display, the causation of display of the plurality of program interface elements comprises displaying the program interface elements on the display, the causation of display of the data source indicator comprises displaying the data source indicator on the display, and the causation of display of the data sink indicator comprises displaying the data sink indicator on the display.

10. A method comprising:
causing display of a plurality of program interface elements;
identifying, from the plurality of program interface elements, of at least one source program interface element that represents a source program, the source program being a program that is configured to send data to one or more programs;
causing display of a data source indicator at a position that corresponds with a position of the source program interface element;
identifying, from the plurality of program interface elements, of at least one sink program interface element that represents a sink program, the sink program being a program that is configured to receive data from one or more programs; and
causing the sink program interface element to comprise a data sink indicator.

11. The method of claim 10, further comprising initiating a program data connection interaction mode, wherein identifying the source program interface element is based, at least in part, on the initiation of the program data connection interaction mode.

12. The method of claim 11, further comprising:
receiving information indicative of a program data connection interaction mode invocation input, wherein the initiation of the program data connection interaction mode is based, at least in part, on the program data connection interaction mode invocation input;
receiving information indicative of a program data connection interaction mode termination input; and
terminating the program data connection interaction mode based, at least in part, on the program data connection interaction mode termination input.

13. The method of claim 10, wherein the data sink indicator is a visual representation of an indentation at an edge of the sink program interface element such that a shape of the indentation corresponds with a shape of an edge of the data source indicator.

14. The method of claim 10, wherein the position of the data source indicator corresponds with a boundary of the source program interface element such that a portion of the data source indicator is within the boundary of the source program interface element and another portion of the data source indicator is beyond the boundary of the source program interface element, such that a shape of the other portion of the data source indicator corresponds with a shape of an edge of the data sink indicator.

15. The method of claim 10, further comprising:
receiving information indicative of a selection input that occurs at a position that corresponds with a position of the data source indicator;
receiving information indicative of a movement input from the position of the data source indicator to a position of the data sink indicator;
receiving information indicative of a deselection input that occurs at a position that corresponds with the position of the data sink indicator;
causing establishment of a data connection between the source program and the sink program based, at least in part, on the selection input, the movement input, and the deselection input;
terminating display of the data source indicator at the position that corresponds with the position of the source program interface element; and
causing display of the data source indicator at a position that corresponds with the position of the data sink indicator.

16. The method of claim 10, further comprising:
initiating a program invocation interaction mode;
determining that a data connection exists between the source program and the sink program;
causing the source program to send data to the sink program based, at least in part, on the data connection between the source program and the sink program;
causing display of a connection indicator between the source program interface element and the sink program interface element based, at least in part, on the data connection; and
causing display of an animation in relation to the connection indicator that is indicative of the source program sending the data to the sink program.

17. At least one computer-readable medium encoded with instructions that, when executed by a processor, perform:
causation of display of a plurality of program interface elements;
identification, from the plurality of program interface elements, of at least one source program interface element that represents a source program, the source program being a program that is configured to send data to one or more programs;
causation of display of a data source indicator at a position that corresponds with a position of the source program interface element;
identification, from the plurality of program interface elements, of at least one sink program interface element that represents a sink program, the sink program being a program that is configured to receive data from one or more programs; and
causation of the sink program interface element to comprise a data sink indicator.

18. The medium of claim 17, further encoded with instructions that, when executed by a processor, perform initiation of a program data connection interaction mode, wherein the identification of the source program interface element is based, at least in part, on the initiation of the program data connection interaction mode.

19. The medium of claim 18, further encoded with instructions that, when executed by a processor, perform:
receipt of information indicative of a program data connection interaction mode invocation input, wherein the initiation of the program data connection interaction mode is based, at least in part, on the program data connection interaction mode invocation input;
receipt of information indicative of a program data connection interaction mode termination input; and
termination of the program data connection interaction mode based, at least in part, on the program data connection interaction mode termination input.

20. The medium of claim 17, wherein the data sink indicator is a visual representation of an indentation at an edge of the sink program interface element such that a shape of the indentation corresponds with a shape of an edge of the data source indicator.
